(19) United States
(12) Patent Application Publication
(10) Pub. No.: US 2026/0244987 A1
(43) Pub. Date: Aug. 20, 2026

(54) Binary Formats for Representing Persistent Parameters and Optimizer Parameters

(71) Applicant: Google LLC, Mountain View, CA (US)

(72) Inventors: Aditya Binodkumar Agrawal, San Jose, CA (US); Gil Joseph Tabak, Boulder, CO (US); Narges Shahidi, San Jose, CA (US)

(21) Appl. No.: 19/193,385

(22) Filed: Apr. 29, 2025

Related U.S. Application Data
(60) Provisional application No. 63/758,899, filed on Feb. 14, 2025.

(51) Int. Cl. G06N 20/00; G06F 7/483; G06F 7/499

(52) U.S. Cl. CPC G06N 20/00; G06F 7/483; G06F 7/49947

(57) ABSTRACT

A method can include obtaining, by a computing system comprising one or more computing devices, a machine-learned model comprising a plurality of parameters having a binary format comprising X exponent bits and Y mantissa bits, wherein a precision of the binary format is not an integer power of two. The method can include, for each of a plurality of training iterations, obtaining, by the computing system, one or more input values for the machine-learned model. The method can include, for each of the plurality of training iterations, generating, by the computing system based at least in part on the input values and based at least in part on the parameters having the binary format, an output. The method can include, for each of the plurality of training iterations, updating, based at least in part on the output, at least one parameter of the plurality of parameters.

### CROSS-REFERENCE TO RELATED APPLICATIONS

The present application is based upon and claims the right of priority to U.S. Provisional Patent Application No. 67/758,899, filed on Feb. 14, 2025, the disclosure of which is hereby incorporated by reference herein in its entirety for all purposes.

### FIELD

The present disclosure relates generally to machine learning processes and machine-learned devices and systems. More particularly, the present disclosure relates to systems and methods for using certain floating-point binary format(s) to represent, during training of a machine-learned model, one or more of: persistent parameters of the machine-learned model; and optimizer parameters of an optimizer process for training the machine-learned model.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by a computing system comprising one or more computing devices, a first machine learning model comprising a first plurality of parameters having a first binary format comprising X exponent bits and Y mantissa bits, wherein a precision of the first binary format is not an integer power of two. The example method can include, for each of a first plurality of training iterations, obtaining, by the computing system, one or more input values for the first machine learning model. The example method can include, for each of the first plurality of training iterations, generating, by the computing system based at least in part on the one or more input values and based at least in part on the parameters having the first binary format, a first output. The example method can include, for each of the first plurality of training iterations, updating, by the computing system based at least in part on the first output, at least one parameter of the first plurality of parameters having the first binary format.

In the example method, the precision of the first binary format can be between 9 and 31 inclusive.

The example method can include obtaining, by the computing system, data indicative of a plurality of parameter update values associated with a second plurality of training iterations, wherein the second plurality of training iterations is performed before the first plurality of training iterations. The example method can include selecting, based at least in part on the plurality of parameter update values, the first binary format.

In the example method, selecting the first binary format can include selecting, based at least in part on a distribution of ratios between pairs of values, a value for Y. In the example method, each pair of values can include a parameter update value of the plurality of parameter update values and a value of a corresponding parameter associated with the parameter update value.

In the example method, selecting the first binary format can include selecting a value for X based at least in part on a distribution of magnitudes of the first plurality of parameters or a second plurality of parameters in relation to a maximum exponent of the first plurality of parameters or the second plurality of parameters.

In the example method, updating the at least one parameter can include determining, by the computing system prior to updating, whether a first value of one or more bits of an update value for the at least one parameter is smaller than a second value of a least significant bit of the at least one parameter. In the example method, updating the at least one parameter can include performing, by the computing system responsive to determining that the first value of the one or more bits of the update value for the at least one parameter is smaller than the second value of the least significant bit of the at least one parameter, a stochastic rounding operation.

In the example method, updating the at least one parameter can include determining, based at least in part on one or more optimizer variables having the first binary format or a second binary format with N exponent bits and Q mantissa bits wherein N+Q+1 is not an integer power of two, an update value for the at least one parameter. The example method can include, for each of the first plurality of training iterations, updating, by the computing system based at least in part on the first output, at least one of the one or more optimizer variables.

In the example method, the one or more optimizer variables can include one or more exponential moving averages associated with one or more gradients of an objective function.

The example method can include obtaining data indicative of a plurality of optimizer variable update values for the optimizer variables during a second plurality of training iterations. In the example method, the second plurality of training iterations can have been performed before the first plurality of training iterations. The example method can include selecting, based at least in part on the plurality of optimizer variable update values, the second binary format.

In the example method, selecting the second binary format can include selecting, based at least in part on a distribution of ratios between pairs of values, a value for Q. In the example method, each pair of values can include an optimizer variable update value and a value of a corresponding optimizer variable associated with the optimizer variable update value.

In the example method, selecting the second binary format can include selecting a value for N based at least in part on a distribution of magnitudes of the one or more optimizer variables during the second plurality of training iterations in relation to a maximum exponent associated with the one or more optimizer variables.

The example method can include converting, by the computing system prior to updating the at least one parameter, the at least one parameter to a second binary format having a higher precision than the first binary format to generate at least one higher-precision parameter. In the example method, updating the at least one parameter can include updating the at least one higher-precision parameter. In the example method, updating the at least one parameter can include converting the higher-precision parameter to the first binary format.

In the example method, converting the at least one parameter can include multiplying, by the computing system, the at least one parameter by one or more scaling factors to generate a scaled parameter. In the example method, converting the at least one parameter can include adding, by the computing system, an offset value to the scaled parameter.

The example method can include converting, by the computing system prior to generating the first output, the at least one parameter to a second binary format having a lower precision than the first binary format to generate at least one lower-precision parameter. In the example method, generating the first output can include performing at least one matrix multiplication using the at least one lower-precision parameter.

Example aspects of the present disclosure provide an example processor device. The example processor device can include one or more floating-point units configured to perform one or more floating-point operations using a first binary format comprising X exponent bits and Y mantissa bits. In the example processor device, a precision of the first binary format can include a precision that is not an integer power of two.

In the example processor device, the one or more floating-point operations can include converting from the first binary format to a second binary format comprising J exponent bits and K mantissa bits, wherein J+K is different from X+Y.

In the example processor device, the one or more floating-point units can be configured to perform floating-point operations associated with a plurality of binary formats comprising at least the first binary format and a second binary format, the second binary format having a total number of bits between 17 and 31 inclusive.

In the example processor device, the one or more floating-point units can be configured to perform stochastic rounding.

Example aspects of the present disclosure provide an example computing system that includes one or more processors and one or more example non-transitory computer-readable media storing instructions that are executable by one or more processors to cause a computing system to perform example operations. In some implementations, the example operations can include obtaining a first machine learning model comprising a first plurality of parameters having a first binary format comprising X exponent bits and Y mantissa bits. In the example operations, a precision of the first binary format can include a precision that is not an integer power of two. The operations can include, for each of a first plurality of training iterations, obtaining one or more input values for the first machine learning model. The operations can include, for each of the first plurality of training iterations, generating, based at least in part on the one or more input values and based at least in part on the parameters having the first binary format, a first output. The operations can include, for each of the first plurality of training iterations, updating, based at least in part on the first output, at least one parameter of the first plurality of parameters having the first binary format.

The example operations can include obtaining data indicative of a plurality of parameter update values associated with a second plurality of training iterations. In the example operations, the second plurality of training iterations can be performed before the first plurality of training iterations. The example operations can include selecting, based at least in part on the plurality of parameter update values, the first binary format.

### BRIEF DESCRIPTION OF THE DRAWINGS

FIG. 1 is a diagram illustrating an example eXmY floating point binary format according to example implementations of aspects of the present disclosure;

FIG. 2 is a block diagram illustrating an example system for training a machine-learned model using persistent parameters having an example eXmY floating-point binary format according to example implementations of aspects of the present disclosure;

FIG. 3 is a block diagram illustrating an example system for training a machine-learned model using persistent parameters having an example eXmY floating-point binary format according to example implementations of aspects of the present disclosure;

FIG. 4 is a block diagram illustrating an example system for training a machine-learned model using optimizer parameters having an example eXmY floating-point binary format according to example implementations of aspects of the present disclosure;

FIG. 5 is a block diagram illustrating an example system comprising a processor device for performing floating-point operations using an example eXmY floating-point binary format according to example implementations of aspects of the present disclosure;

FIG. 6 is a flow chart diagram of an example method for training a machine-learned model using persistent parameters having an example eXmY floating-point binary format according to example implementations of aspects of the present disclosure;

FIG. 7 is a flow chart diagram of an example method for selecting an eXmY floating-point binary format for training a machine-learned model according to example implementations of aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

Generally, the present disclosure is directed to training a machine-learned model using persistent parameters that are represented in example floating-point binary formats referred to herein as eXmY binary formats. Training a machine-learned model can include, for example, storing a plurality of persistent parameters having a first precision; and, for each of a plurality of training iterations: converting the persistent parameters to temporary parameters having a second, lower precision (e.g., float 16, bfloat 16, etc.); performing matrix multiplication(s) using the lower-precision temporary parameters; and updating the persistent parameters based on a result of the matrix multiplication(s). In some instances, the persistent parameters can be stored in an eXmY binary format to reduce a computational cost associated with storing, transmitting, or performing operations on the persistent parameters compared to some alternative implementations. An eXmY binary format can include, for example, a binary format having X exponent bits and Y mantissa bits, wherein a precision of the eXmY binary format (i.e., bitwidth, such as X+Y+1) is not required to be an integer power of 2. For example, in some instances, persistent parameters can be stored in example eXmY binary formats having a precision between 2 and 64 inclusive, such as between 9 and 31 inclusive, such as between 17 and 31 inclusive, such as between 20 and 24 inclusive.

In some instances, an eXmY binary format can be selected based at least in part on parameter update data, such as data obtained from a plurality of past training iterations. For example, each of a plurality of respective parameter update values from a plurality of training iterations can be compared to a corresponding parameter value that was updated according to the respective update value, and a number Y of mantissa bits for the binary format can be selected based on the comparison. For example, a ratio of each respective parameter update values to a corresponding parameter value can be obtained, and a number Y of mantissa bits can be selected based on a distribution of the ratios. For example, in some instances, an expected rounding loss associated with a number Y of mantissa bits can be determined based on a number (i.e., count) or magnitude of a plurality of update values that are smaller than 2^{-Y} times a corresponding parameter value being updated, and a preferred (e.g., optimal, near-optimal, etc.) number of mantissa bits can be selected based on a plurality of expected rounding losses associated with a plurality of possible values for Y. For example, in some instances, a plurality of expected rounding losses can be compared to a rounding loss threshold (e.g., 1 percent, 2 percent, 5 percent, 10 percent, 20 percent, 50 percent, etc.), and a smallest number of mantissa bits having an expected rounding loss below the threshold can be selected. As another example, in some instances, a hardware resource budget (e.g., memory bandwidth budget, storage budget, processor budget, etc.) can be obtained, and a preferred number of mantissa bits can be selected based on the budget (e.g., alone or in combination with other training hyperparameter selections, etc.). For example, in some instances, an expected rounding loss associated with reducing a value of Y can be compared with an expected gain from reallocating hardware resources (e.g., memory resources, processor resources, etc.) that may be conserved by reducing the value of Y.

Similarly, in some instances, a number X of exponent bits can be selected based on training data (e.g., past training data, estimated future training data, etc.). For example, in some instances, a number X of exponent bits can be selected based on a distribution of magnitudes of a plurality of parameters (e.g., all parameters of a machine-learned model, etc.) or update values for the parameters in relation to a maximum value (e.g., maximum exponent, etc.) of the plurality of parameters. For example, in some instances, an expected rounding loss associated with a number X of exponent bits can be determined based on a number or magnitude of a plurality of parameters or update values having an exponent that is smaller than 2^{-X} times a maximum exponent of a plurality of parameters (e.g., all parameters of a machine-learned model, etc.). In some instances, a value of X can be selected based on the expected rounding loss (e.g., in any manner described above with respect to a value of Y, etc.).

In some instances, an expected rounding loss can be determined based at least in part on a learning rate parameter associated with parameter update data. For example, in some instances, one or more past learning rate parameters used to determine past parameter update values may be the same as or different from a future learning rate parameter to be used to train a machine-learned model using an eXmY binary format. In such instances, a ratio between a parameter update value and one or more corresponding values of one or more parameters to be updated can be proportional to a learning rate used to determine the parameter update value. In some instances, an expected rounding loss associated with the future learning rate parameter can be determined based on the past parameter update data and based on a ratio between the future learning rate parameter and the past learning rate parameter(s). For example, past parameter update values can be scaled based on a ratio between the future learning rate parameter and the past learning rate parameter(s), and an expected rounding loss can be determined based on the scaled values.

In some instances, determining a parameter update according to some aspects of the present disclosure can include stochastic rounding. Stochastic rounding can include, for example, determining that one or more least significant bit(s) of a parameter update value are smaller than a least significant bit of a corresponding value (e.g., eXmY value) to be updated; and randomly determining, based on a magnitude of the one or more least significant bits, whether to round the parameter update value up or down. In some example experiments according to aspects of the present disclosure, stochastic rounding reduced a training loss by an amount equivalent to about four additional mantissa bits of precision. For example, in some experiments, a first machine-learned model trained using 20-bit persistent parameters (e.g., e3m16-formatted parameters) and stochastic rounding was associated with results (e.g., training loss, BLEU scores, ROUGE-2 scores, etc.) similar to a second machine-learned model trained using 24-bit persistent parameters (e.g., e3m20-formatted parameters) and deterministic rounding.

In some instances, parameters other than a machine-learned model's persistent parameters can be stored in an eXmY binary format that is the same as or different from a format of the persistent parameters. For example, in some instances, a training process can include an optimization process (e.g., Adam, etc.) based on one or more optimizer variables, such as momentum variables, moving averages (e.g., exponential moving averages, etc.), or other optimizer variables. As a non-limiting illustrative example, an Adam optimization process can include determining one or more exponential moving averages associated with a plurality of gradients associated with a plurality of training iterations; and determining one or more adaptive learning rate parameters based on the exponential moving average(s). Continuing the example, the exponential moving averages can be stored in an eXmY binary format (e.g., e3m2, e3m8, etc.) that is the same as or different from a format of the persistent parameters, thereby reducing a computational cost (e.g., memory footprint, memory bandwidth, etc.) associated with storing and using Adam optimizer parameters. In some instances, an eXmY binary format for storing optimizer parameters can be selected in a manner similar to (e.g., same as) any manner described herein with respect to an eXmY binary format for storing and using persistent model weights.

In some instances, training a machine-learned model using parameters (e.g., persistent model weights, optimizer parameters, etc.) having an eXmY binary format can include performing operations (e.g., multiplications, additions, etc.) natively in the eXmY binary format, or can include converting numbers stored in the eXmY binary format to another format (e.g., 32-bit float, 16-bit float or bfloat, 8-bit float, etc.) before performing operations (e.g., matrix multiplication operations, etc.) in the other format, or both. In some instances, storing a plurality of parameters (e.g., optimizer parameters, persistent model weights, etc.) in an eXmY binary format, or converting the parameters to or from the eXmY binary format, can include scaling or offsetting the parameters based on a range of current values of the plurality of parameters.

In some instances, a computing system for training machine-learned models according to some aspects of the present disclosure can include one or more hardware devices (e.g., processor devices, floating-point units, etc.) configured to perform operations using one or more eXmY formats, such as hardware configured to convert an eXmY-formatted value to a corresponding value in another format (e.g., 32-bit floating point, bfloat 16; 8-bit floating point; 4-, 2-, or 1-bit integer or floating point, etc.) or vice versa; hardware configured to perform operations natively in one or more eXmY formats (e.g., generating e3m20-formatted outputs based on e3m20-formatted inputs, etc.); or other operations. Additionally, in some instances, a computing system according to some aspects of the present disclosure can include one or devices for performing stochastic rounding operations (e.g., random or pseudorandom number generation, random or pseudorandom branching, etc.).

Systems and methods according to some aspects of the present disclosure can provide a variety of technical effects and benefits, such as improvements to computing technology (e.g., machine learning training technology). For example, in some instances, systems and methods according to some aspects of the present disclosure can reduce a computational cost (e.g., high-bandwidth memory usage, memory footprint, processor usage associated with parameter rematerialization, communication overhead, hardware capital cost, etc.) of training a machine-learned model compared to some alternative implementations, thereby improving the functioning of a computing system performing the training. As another example, in some instances, systems and methods according to some aspects of the present disclosure can provide other technical effects and benefits, such as increased training throughput; improved performance (e.g., inference output quality, training loss, etc.) of a machine-learned model; or other benefits compared to some alternative implementations.

In some instances, systems and methods according to some aspects of the present disclosure can reduce a computational cost of training a machine-learned model compared to some alternative implementations. For example, in some training operations (e.g., Adam optimization, etc.), a combined memory cost (e.g., memory footprint, memory bandwidth usage, etc.) associated with a plurality of persistent model weights and a plurality of optimizer variables can be approximately 50 percent of a total memory cost of the training operation. By quantizing such parameters according to an eXmY format (e.g., 20-bit e3m16 format, 6-bit e3m2 format for optimizer parameters, etc.), a memory cost of storing and using such parameters can be reduced, thereby reducing a total memory cost (e.g., by about 9 percent in some example experiments, etc.) of the training operation compared to some alternative implementations. As another example, in some instances, reducing a per-parameter memory cost of a training operation can in some instances enable an increased number of parameters that can be processed by a single processor device, thereby reducing a number of processors required to perform a multi-processor training computation (e.g., parallel computation, etc.), thereby reducing a hardware cost associated with the computation. Additionally, in some instances, reducing a number of processors required to perform a given computation can reduce an amount of communication overhead required to communicate between a plurality of processors during the computation, thereby reducing a communication cost associated with the computation. As another example, in some instances, reducing a per-parameter memory cost (e.g., memory bandwidth cost, etc.) of a training operation can reduce an amount of parameter rematerialization (i.e., recomputation) that may be required during the training operation, thereby reducing an amount of processor usage associated with the training iteration. Other cost reductions are possible.

In some instances, systems and methods according to some aspects of the present disclosure can provide other technical effects and benefits, such as increased training throughput or improved performance (e.g., inference output quality, training loss, etc.) of a machine-learned model trained using an eXmY format. For example, in some instances, reducing a per-parameter memory cost of a training operation can increase a number of parameters that can be processed by a given number of processor devices (e.g., one, etc.) in a given period of time, thereby increasing a training throughput of a computing system comprising the given number of processor devices. As another example, in some instances, methods that can enable reduced-computational-cost training of a machine-learned model having a given complexity (e.g., parameter count, etc.) or computational cost can be adapted to enable similar-computational-cost training of a machine-learned model having an increased complexity (e.g., increased parameter count, etc.). In some instances, a performance quality (e.g., inference output quality, etc.) of a machine-learned model can increase as a complexity of the model increases, thereby improving a performance of the machine-learned model compared to some alternative implementations.

As used herein, the terms “about” or “approximately,” in conjunction with a numerical value, refer to within 25 percent of the numerical value.

Various example implementations are described herein with respect to the accompanying Figures.

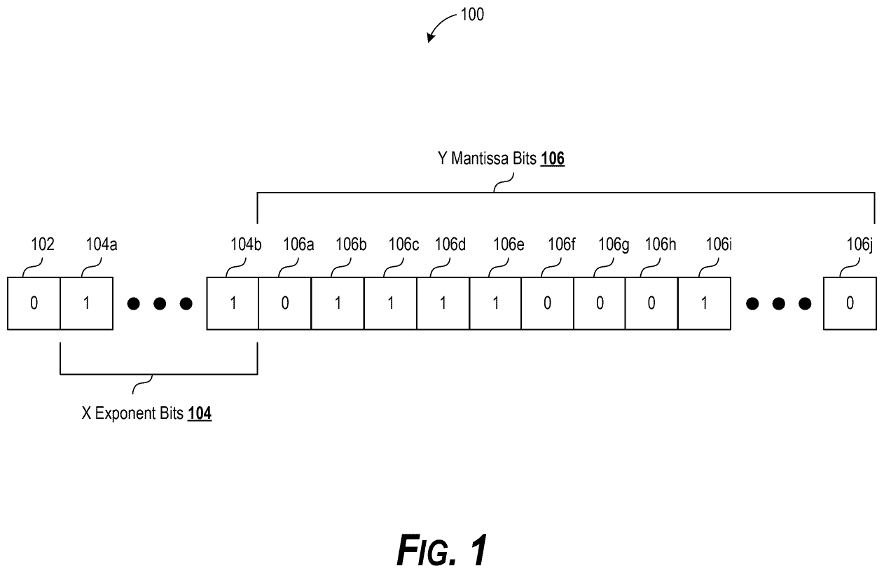

FIG. 1 is a diagram illustrating an example eXmY floating point binary format according to example implementations of aspects of the present disclosure. A number represented in an eXmY binary format can include a sign bit 102; X exponent bits 104; and Y mantissa bits 106, wherein X and Y can be positive integers. The sign bit 102 can indicate, for example, whether the number is greater than or less than a value of interest (e.g., zero, median value or central value of a range being represented, etc.). The exponent bits 104 and mantissa bits 106 together can indicate a magnitude associated with the number, such as a magnitude (e.g., absolute value, etc.) of a distance between the number and the value of interest (e.g., zero). For example, the mantissa bits 106 can represent a Y-bit binary number N, such as a binary number between 1 and 2, and the exponent bits 104 can represent a value for adjusting (e.g., scaling, etc.) the mantissa bits 106. For example, the X exponent bits can represent an X-bit binary number (e.g., integer, etc.) Q, and the number represented in the eXmY binary format can be proportional to N*base^{Q}, where base can be a real number (e.g., integer such as 2 or 10). In some instances, the number represented in the binary format can be a scaled or offset value, such as

S*N*2^{Q}+O, where S is a numerical scaling factor, and O is a numerical offset value.

A sign bit 102 can be, for example, a bit indicating whether a number represented in the eXmY format of FIG. 1 is greater than or less than a value of interest (e.g., zero, median value, central value, etc.). For example, in some instances, an eXmY binary format having X exponent bits 104, Y mantissa bits 106, and one sign bit 102 can be configured to represent numbers between −K and about K, where K can be a real number and the sign bit 102 can indicate whether a number being represented by the bits 102, 104, 106 is greater than or less than zero. As another example, in some instances, an eXmY binary format can be used to represent a range that is not symmetrical about zero, and the sign bit 102 can indicate whether the number represented is greater than or less than a value other than zero, such as a center or median of the range or the like. In some instances, a sign bit 102 can be omitted, and a range of values (e.g., between zero and K; between O and K+O, wherein O is a real-numbered offset value; etc.) can be represented using only exponent bits 104 and mantissa bits 106. In some instances, a sign bit 102 can have or not have any property described in the Institute of Electrical and Electronics Engineers (IEEE) standard IEEE 754 (e.g., IEEE 754-2019, etc.) with respect to sign bits of another floating-point format (e.g., binary16, binary32, decimal32, binary64, decimal64, etc.).

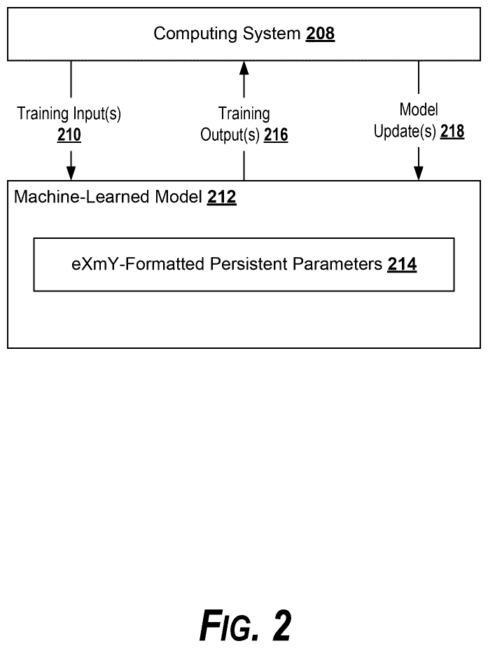

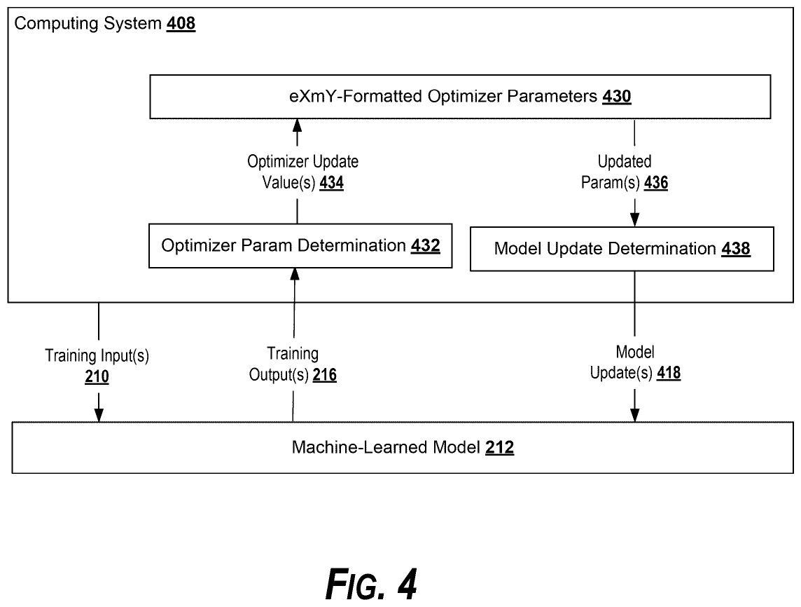

The exponent bit(s) 104 can include, for example, bits used to represent a scaling value by which a mantissa value represented by one or more mantissa bits 106 can be scaled. For example, in some instances, the exponent bits collectively can represent a first number E in a binary integer format (e.g., unsigned integer, signed integer, etc.), and a value M represented by the mantissa bits can be scaled based on the first number E. For example, in some instances, the value M can be multiplied by B^{E}, wherein B can be a positive real-valued (e.g., integer-valued, etc.) exponent base (e.g., 2, 10, 3, 4, or another real number). As another example, in some instances, the value M can be multiplied by B^{E+O}^{ₑ}, wherein Oₑ is a real-valued (e.g., integer-valued, etc.) exponent offset. In some instances, exponent bits 104 can have or not have any property described in the Institute of Electrical and Electronics Engineers (IEEE) standard IEEE 754 (e.g., IEEE 754-2019, etc.) with respect to exponent bits of another floating-point format (e.g., binary 16, sometimes referred to as “half precision”; binary32, sometimes referred to as “single precision”; decimal32; binary64, sometimes referred to as “double precision”; decimal64; etc.). In some instances, values for B, Oₑ, and X can be selected based at least in part on a range of numbers to be represented using the eXmY binary format of FIG. 1. Further details of some example methods for selecting one or more eXmY binary formats (including, e.g., values of B, Oₑ, or X for a binary format) for use in training a machine-learned model are provided below with respect to FIGS. 2 and 4.

The mantissa bit(s) 106 can include, for example, bits used to represent a mantissa value (sometimes referred to as a “significand” value, etc.) to be scaled by the sign bit 102 or exponent bits 104. For example, in some instances, the mantissa bits 106 can represent a value to be added to 1 to arrive at a mantissa value M, wherein the mantissa bits 106 represent numbers to the right of a decimal point in binary notation (e.g., M=1M₁M₂M₃M₄ . . . . M_{Y}, where Mᵢ refers to an i^{th} most significant bit of the mantissa bits 106, etc.). As another example, in some instances, a number represented by the mantissa bits 106 (e.g., treating some or all of the mantissa bits 106 as bits to the right of a decimal point in binary notation, etc.) can be added to another value (e.g., mantissa offset value Om, etc.) to arrive at a mantissa value M to be scaled according to the exponent bits 104. Other implementations are possible. In some instances, mantissa bit(s) 106 can be omitted, and exponent bits 104 or sign bit 102 can scale a constant mantissa value. In some instances, mantissa bits 106 can have or not have any property described in the Institute of Electrical and Electronics Engineers (IEEE) standard IEEE 754 (e.g., IEEE 754-2019, etc.) with respect to mantissa bits of another floating-point format (e.g., binary16, binary32, decimal32, binary64, decimal64, etc.). In some instances, a range of possible mantissa values M to be represented by mantissa bits 106 of an eXmY binary format can be selected according to one or more methods described below with respect to FIG. 2 or FIG. 4.

In some instances, a value represented in an eXmY binary format can be a scaled or offset value (e.g., according to a scaling and offset inherent in the binary format; according to a separate scaling and offset; etc.). As a non-limiting illustrative example, an eXmY binary format configured to represent values between −K and about K can be used to represent values between about −S*K+0 and about S*K+0, wherein S is a scaling value and O is an offset value. As a non-limiting illustrative example, some eXmY binary formats can be used to represent numbers of the format S*M*B^{E}+0; S*M*B^{S}^{ₑ}^{E+O}^{ₑ}+O, where Sₑ is an exponent scaling value; or the like. Further details of some example implementations for identifying a range of numbers to be represented, and selecting an eXmY binary format, scaling value, or offset value to represent the range of numbers are described below with respect to FIGS. 2 and 4.

In some instances, an eXmY binary format according to aspects of the present disclosure can differ from alternative floating-point formats (e.g., IEEE 754 formats, bfloat16, TensorFloat-32, etc.) in one or more ways. For example, in some instances, a precision (i.e., bitwidth; total number of bits required to represent each number; X+Y+1, where X is a number of exponent bits 104, Y is a number of mantissa bits 106, and 1 is a number of sign bits 102 used to represent each number; etc.) of an example eXmY binary format according to some aspects of FIG. 1 can be a number that is not an integer power of two. For example, in some instances, some example eXmY binary formats according to aspects of the present disclosure can have a precision between 1 and 64 (e.g., inclusive) bits per numerical value represented, such as between 9 and 31 inclusive, such as between 17 and 31 inclusive, such as between 20 and 28 inclusive, such as between 20 and 24 inclusive. Other precisions are possible (e.g., 33 and above such as up to 64 bits, 15 and below, etc.). As another example, in some instances, the exponent bits 104 can be configured to represent a range of possible exponent values different from a range associated with an IEEE 754 format having a similar (e.g., same) number of exponent bits, such as a range having a median or central value that is not near zero. As another example, the mantissa bits 106 can be configured to represent a range of possible mantissa values different from a range associated with an IEEE 754 format having a similar (e.g., same) number of mantissa bits, such as a scaled range that is wider or narrower than an IEEE 754 range; an offset range having a center, median, minimum, or maximum value that is different from a corresponding IEEE 754 value; or the like.

FIG. 2 is a block diagram illustrating an example system for training a machine-learned model 212 using persistent parameters 214 (e.g., persistent model weights, etc.) having an eXmY floating-point binary format according to example implementations of aspects of the present disclosure. A computing system 208 can provide one or more training inputs 210 to a machine-learned model 212 having a plurality of eXmY-formatted persistent parameters 214. The machine-learned model 212 can generate, based at least in part on the training inputs 210 and using the eXmY-formatted persistent parameters 214, one or more training outputs 216. The computing system 208 can evaluate the training output(s) 216 (e.g., according to a loss function or other objective function, etc.), and provide one or more model updates 218 based on the evaluation. Based on the model updates 218, the eXmY-formatted persistent parameters 214 can be updated, and additional training iteration(s) can be performed.

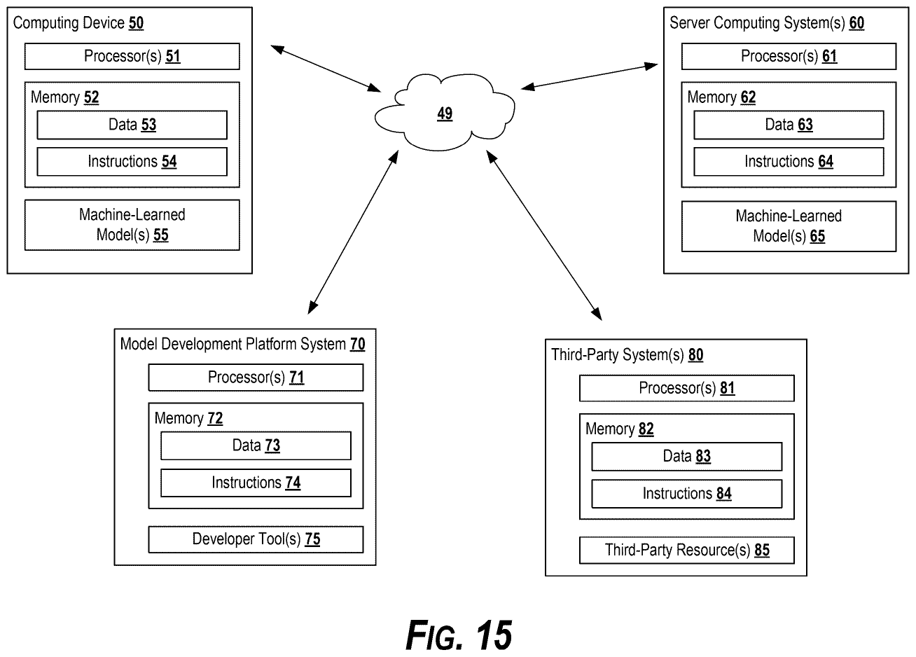

A computing system 208 can be or include one or more software, firmware, or hardware components configured to train machine-learned model(s) 212 using eXmY-formatted persistent parameters 214. In some instances, the computing system 208 can be, comprise, be comprised by, or share one or more properties with a computing device or system described below with respect to FIGS. 15-17 (e.g., computing device 50, third-party system 80, computing device 98, computing device 99, etc.).

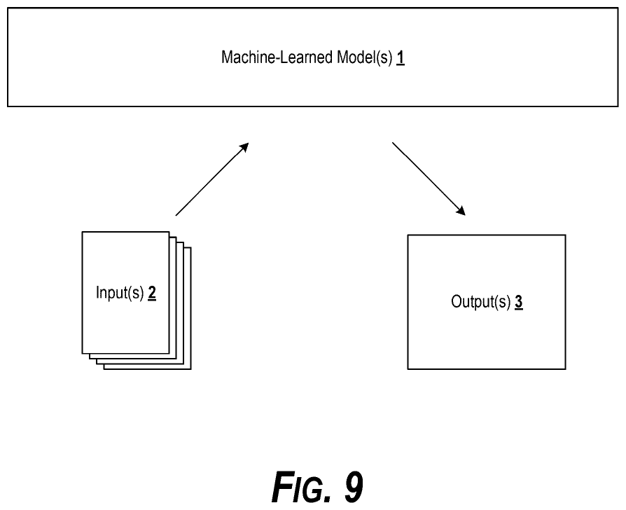

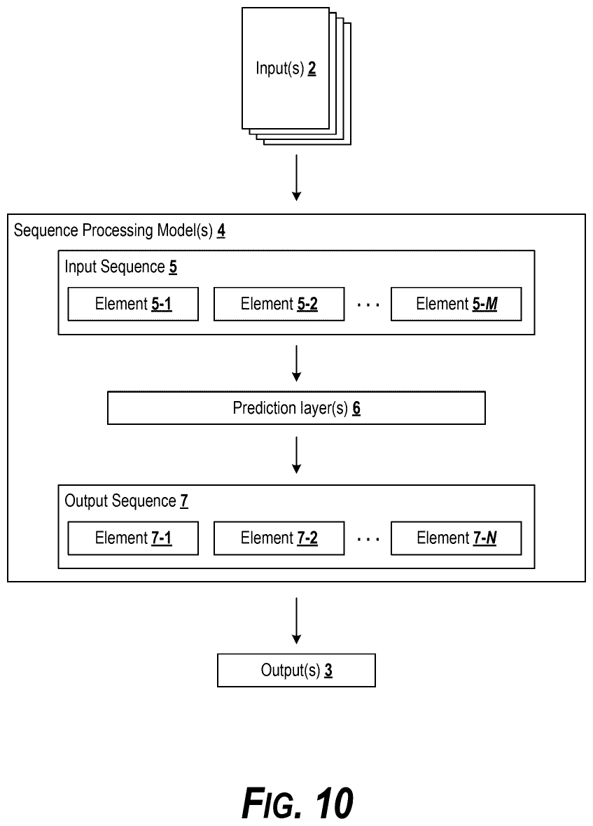

A training input 210 can generally include or otherwise represent various types of data. An training input 210 can include one type or many different types of data. Example data types for an training input 210 can include, for example, any data type described below with respect to FIGS. 9-10 and inputs 2, such as language data (e.g., natural language data such as text or speech data, programming language data, etc.), sequence data (e.g., language sequence, time series, etc.), image data, audio data, video data, or another data type.

A machine-learned model 212 can include one or more machine-learned models, such as machine-learned models having one or more (e.g., a plurality of) eXmY-formatted persistent parameters 214. The machine-learned model 212 can include various model architectures, such as various neural network model architectures. An example model architecture for a machine-learned model 212 can include a sequence processing model architecture (e.g., a transformer model). For example, the machine-learned model(s) 212 can be configured to receive an input sequence and generate an output sequence. For instance, the machine-learned model 212 can be configured to generate an output sequence where elements of the output sequence are predicted based on the elements of the input sequence. In some instances, a machine-learned model 212 can include a model architecture having an attention mechanism (e.g., self-attention). In some instances, the machine-learned model 212 can be a pre-trained model (e.g., pretrained using large-scale unsupervised learning). In some instances, the machine-learned model 212 can be fine-tuned over one or more fine-tuning datasets, such as a fine-tuning dataset associated with one or more specialized generation tasks. In some example experiments according to some aspects of the present disclosure, the machine-learned model 212 included a pretrained mixture-of-experts model, and training update(s) 218 of the example experiments included supervised fine-tuning updates. Other implementations are possible.

An eXmY-formatted persistent parameter 214 can include, for example, a persistent parameter (e.g., weight, etc.) of the machine-learned model 212 having an eXmY binary format with X exponent bits 104, Y mantissa bits 106, and zero or more (e.g., one) sign bits 102, wherein a precision (e.g., X+Y+1, etc.) of the binary format can include a precision that is not an integer power of two. An eXmY binary format of an eXmY-formatted persistent parameter 214 can have, for example, any property described herein with respect to FIG. 1.

As used herein, the term “persistent” parameter can refer to parameters that persist (e.g., either changed or unchanged by model update(s) 218) throughout a plurality of training iterations. For example, in some instances, persistent parameters can refer, for example, to model parameters (e.g., weights, etc.) stored at a first precision (e.g., X+Y+1 bit, 32-bit, etc.), wherein the weight(s) can be temporarily converted to a reduced precision (e.g., 16-bit precision such as float16 or bfloat16, sometimes referred to as “brain floating point”; 8-bit or lower-bit quantized precision; etc.), for one or more high-computational-cost operations, such as matrix multiplication operations performed during a forward pass of the machine-learned model 212 to generate a training output 216 or during a backward pass to determine a model update 218. In some instances, one or more reduced-precision outputs of the high-computational-cost operation(s) can then be used to generate a higher-precision update value, and can be used to update the higher-precision stored model parameters (e.g., weights). In such instances, the converted reduced-precision weights can be referred to as temporary weights, and the higher-precision weights that persist between training iterations can be referred to as persistent weights. Other terms can be used to refer to such persistent weights, such as full-precision weights or higher-precision weights; primary weights; or other appropriate terminology. In some instances, an eXmY-formatted persistent parameter 214 can include any type of machine-learned model 212 parameter, such as a weight (e.g., neural network weight, weight associated with a fully connected layer, weight associated with a self-attention layer such as a key or query weight, etc.) or other parameter (e.g., spline parameter, time-constant parameter, etc.).

In some instances, one or more eXmY binary formats for the eXmY-formatted persistent parameters 214 can be selected based on training data. For example, in some instances, a binary format can be selected based on data collected from past training iterations, such as earlier training iterations of the machine-learned model 212 or earlier training iterations associated with a different machine-learned model (e.g., model that may have similar properties, or may have been trained according to a similar training process compared to the machine-learned model 212, etc.). In some instances, past training iterations can include training iterations having properties (e.g., loss function, learning rate parameter, optimizer algorithm such as Adam, etc.) that are similar to (e.g., same as) or different from one or more properties of the training process of FIG. 2 for training the machine-learned model 212. As another example, in some instances, a binary format can be selected based on expectation data indicative of future training iterations, such as expectation data indicative of an expected statistical distribution of training update 218 magnitudes; expected statistical distribution of ratios between training updates 218 and corresponding eXmY-formatted persistent parameters 214 being updated; or the like.

In some instances, selecting an eXmY binary format for storing the eXmY-formatted persistent parameters 214 can include selecting a number of mantissa bits. In some instances, a number of mantissa bits can be selected based at least in part on a statistical distribution associated with the training data, such as a statistical distribution (e.g., past distribution, expected distribution, etc.) of ratios between respective training updates 218 and corresponding parameters updated according to the training updates 218. For example, in some instances, a ratio between a respective training update 218 and corresponding parameter updated by the training update 218 can be indicative of a threshold number of mantissa bits required to cause the training update 218 to have a magnitude greater than a magnitude of a least significant bit of the corresponding parameter being updated when the training update 218 and corresponding parameter to be updated are represented using a common exponent. As a non-limiting illustrative example, a three-bit binary format can represent eight (23) distinct values, such as values from 0 to 7. Continuing the example, a three-mantissa-bit binary format can represent values between, for example, 0*base^{exponent} and 7*base^{exponent} In such instances, if a ratio between a parameter to be updated and a corresponding training update 218 is greater than about 7 (e.g., greater than about 2³ or 2³−1, where 3 is the number of mantissa bits available), then the value of the training update 218 may be less than the least significant bit of any number used to represent the corresponding parameter to be updated. Similarly, the ratio between the respective training update 218 and the corresponding parameter updated by the training update 218 can also be indicative of other thresholds, such as a number of mantissa bits required to cause the training update 218 to have a quantized magnitude that is within a threshold percentage (e.g., about 5 percent, about 10 percent, about 20 percent, about 30 percent, about 50 percent, etc.) of a magnitude of a full-precision (e.g., 64-bit, 32-bit, etc.) representation of the training update 218; a number of mantissa bits required to cause a rounding loss to be below a rounding loss threshold (e.g., percentage threshold, magnitude threshold, etc.) when representing the training update 218 and a corresponding parameter to be updated using a common exponent; or the like.

In some instances, a number of mantissa bits can be selected based in part on an application of one or more rules, such as one or more thresholds. For example, in some instances, a number of mantissa bits can be selected based on a percentage threshold, such as a percentage of training updates 218 having a value that is smaller than a least significant bit of a corresponding parameter to be updated when represented using a common exponent, or smaller than another magnitude threshold (e.g., J times a least significant bit, wherein J is a real number; 2^{-Y} or 2^{-Y}−1 times a magnitude of the corresponding parameter to be updated, wherein Y is a number of mantissa bits; or the like); a percentage of training updates 218 having a rounding loss that is smaller than a rounding loss threshold when represented using a common exponent with the corresponding parameter to be updated; or the like. Selecting a number of mantissa bits based on a percentage threshold can include, for example, selecting the minimum number of mantissa bits to cause a percentage value (e.g., number of training updates 218 larger than J times a least significant bit, etc.) to satisfy (e.g., exceed, etc.) a percentage threshold (e.g., about 50 percent, about 60 percent, about 70 percent, about 80 percent, about 90 percent, about 95 percent, about 98 percent, about 99 percent, etc.).

As another example, in some instances, a number of mantissa bits can be selected based on a magnitude threshold, such as a threshold magnitude of an expected average (e.g., arithmetic or geometric mean, median, etc.) rounding loss when representing a plurality of training updates 218 and corresponding training parameters to be updated using a common exponent, or the like. Selecting a number of mantissa bits based on a magnitude threshold can include, for example, selecting the minimum number of mantissa bits to cause a value to satisfy (e.g., fall below, etc.) the magnitude threshold.

In some instances, a number of mantissa bits can be selected based on a tradeoff between rounding loss and computational cost, or based on a computational resource budget, or the like. For example, in some instances, a plurality of candidate numbers of mantissa bits or candidate eXmY binary formats can be evaluated. For each candidate format being evaluated, one or more expected costs of representing training updates 218 and eXmY-formatted persistent parameters 214 in the candidate format can be determined, such as one or more of: an expected distribution of rounding errors comprising a difference between a full-precision training update 218 and reduced-precision training update 218 represented in the candidate format; an expected training reward/loss differential comprising an expected difference in values of an objective function during training; an expected difference in time to convergence of a training algorithm; an expected difference in evaluations of inference quality of a trained model, such as BLEU scores or the like; or other cost values. Additionally, for each candidate format being evaluated, one or more expected benefits of representing training updates 218 or eXmY-formatted persistent parameters 214 in the candidate format can be determined, such as one or more of an expected reduction in memory bandwidth used during training, an expected reduction in memory footprint, an expected increase in slice size or batch size, an expected reduction in processor usage due to reduced rematerialization of parameters; or the like. In some instances, an eXmY binary format for representing the training updates 218 and eXmY-formatted persistent parameters 214 can be selected based on the determined costs and benefits. In some instances, selecting a binary format based on costs and benefits can include, for example, selecting a lowest-computational-cost candidate format that exceeds an expected quality threshold (e.g., BLEU score threshold, etc.); selecting a highest-quality candidate format having a computational cost below a cost threshold; selecting a candidate format having a highest evaluation score according to a scoring formula that penalizes computational cost and rewards inference quality according to a predetermined formula; or the like. In some instances, selecting a binary format according to a computational resource budget can include, for example, selecting a combination of training conditions (e.g., hyperparameters, hardware resource allocations, etc.), wherein the training conditions include one or more eXmY binary formats for representing eXmY-formatted persistent parameters 214, that generate the highest-quality outcome (e.g., highest BLEU score, lowest training loss, fastest convergence, etc.) given a computational resource budget.

A computational resource budget can include, for example, a hardware resource budget; one or more usage budgets, such as electricity usage, computing system usage as measured in wall clock time; financial cost budgets; or other resource budgets. For example, in some instances, a hardware resource budget can include a budget comprising a given number of computing devices, with each computing device having a given hardware configuration, such as one or more given processor devices, memory devices, communication devices, and the like. In some instances, each hardware component of a computing device can have one or more resource budgets indicative of a maximum amount of a resource the hardware component can produce, such as a memory bandwidth budget, a memory capacity or memory footprint budget, a floating-point operations per second (FLOPS) budget, or the like. In some instances, selecting an eXmY binary format can include performing combinatorial analysis to select a preferred (e.g., optimal or near-optimal quality or quality-cost tradeoff, etc.) combination of training conditions (e.g., hardware allocations, hyperparameters, binary formats, etc.) for the resource budget.

In some instances, a number of exponent bits X for an eXmY binary format can be selected based on training data (e.g., training data described above with respect to mantissa bits). In some instances, a number of exponent bits X can be based on a ratio between a maximum (e.g., past maximum, expected maximum, etc.) parameter value (e.g., maximum absolute value, etc.) and minimum parameter value (e.g., minimum absolute value, etc.) of a plurality of parameters (e.g., persistent model weights, etc.); based on a ratio between a maximum parameter value (e.g., maximum absolute value, etc.) of a plurality of parameters to be updated, and a minimum training update value (e.g., minimum absolute value, etc.) for updating the parameters (e.g., wherein the minimum training update is associated with a different parameter from the maximum parameter value, etc.); or the like. For example, in some instances, an expected rounding error associated with representing a plurality of eXmY-formatted binary parameters 214 using a candidate number of exponent bits can be determined based on a ratio between the maximum absolute value and minimum absolute value. As a non-limiting illustrative example, a number X of exponent bits can be used to represent a range of 2^{X} possible exponent values, such as 0 through 2^{X}−1. In some instances, a ratio between a least significant bit of a number represented using a maximum exponent value of a range of exponent values and a least significant bit of a number represented using a minimum exponent value of the range of exponent values can be equal to base²^{^{X}}⁻¹, wherein base is an exponent base associated with the eXmY binary format (e.g., 2, 10, etc.). In such instances, a maximum-to-minimum ratio greater than base²^{^{X}}⁻¹ may lead to some rounding loss attributable to a reduced number of exponent bits. In some instances, a number of exponent bits for representing the eXmY-formatted persistent parameters 214 can be selected in any manner described above with respect to mantissa bits, with appropriate substitutions (e.g., minimum-absolute-value-to-maximum-absolute-value ratio instead of update-to-parameter ratio; rounding loss attributable to reduced exponent precision instead of rounding loss attributable to reduced mantissa precision; etc.). For example, a number of exponent bits can be selected based on one or more of: a percentage of parameters having an exponent smaller than about 2^{X}−1 less than a maximum exponent; an average magnitude of parameters having an exponent smaller than about 2^{X}−1 less than a maximum exponent; an average expected rounding loss associated with representing a plurality of parameters using X exponent bits; a number or percentage of parameters having an expected rounding loss associated with representing a plurality of parameters using X exponent bits that is above a rounding loss threshold; or the like.

In some instances, an eXmY binary format can be selected based at least in part on test data, such as data collected from a plurality of tests performed based on a plurality of eXmY binary formats. For example, in some instances, a plurality of machine-learned models (e.g., lightweight models having a reduced computational cost or complexity compared to the machine-learned model 212, etc.) can be trained or partially trained (e.g., in a reduced number of training iterations or other lower-cost training operations compared to the training process of FIG. 2) using a plurality of candidate binary formats, and a performance (e.g., inference quality according to one or more evaluation scores, such as BLEU scores, etc.) of the plurality of models can be compared. Based on comparison(s) of performance and training cost, a preferred eXmY binary format for representing eXmY-formatted persistent parameters 214 during the training process of FIG. 2 can be selected.

A training output 216 can generally include or otherwise represent various types of data. A training output 216 can include one type or many different types of data. A training output 216 can include one or more data types that are similar to (e.g., same as) or different from one or more data types of a training input 210. Example data types for a training output 216 can include, for example, any data type described below with respect to FIGS. 9-10 and outputs 3.

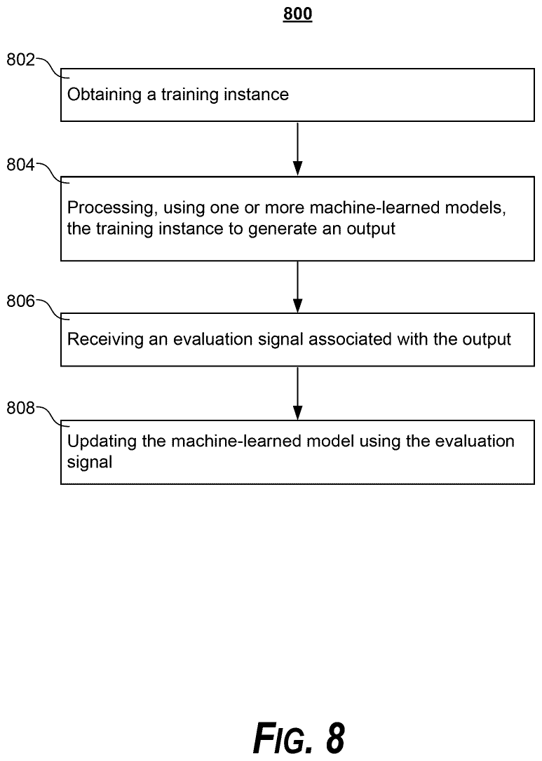

A model update 218 can include, for example, a value (e.g., numerical value, etc.) for updating one or more parameters of the machine-learned model 212, an action for updating the machine-learned model 212, or the like. For example, in some instances, a model update 218 value can include a numerical adjustment value to be combined with (e.g., added to, multiplied by, etc.) a parameter of the machine-learned model 212 to generate an updated parameter. In some instances, a model update 218 can be determined based on an evaluation of a training output 216, such as evaluation using a loss function, reward function, or other objective function. For example, in some instances, a training output 216 can be compared to a ground truth output according to a loss function. In some instances, a gradient of an objective function with respect to one or more training outputs (e.g., mini-batch comprising a plurality of loss values associated with a plurality of training outputs 216, etc.) can be determined, and the model updates 218 can be determined based on one or more gradients (e.g., by multiplying the gradient by a constant or adaptive learning rate parameter, etc.). Further details of some example methods for updating a machine-learned model are provided below with respect to FIGS. 4 and 8.

In some instances, determining a training update 218 can include stochastic rounding. Stochastic rounding can include, for example, determining that a portion (e.g., all or part, etc.) of a training update 218 value is smaller than a least significant bit of a binary format used to represent the training update 218 and a corresponding parameter to be updated using a common exponent; and randomly determining, based on a ratio between the portion and the least significant bit, whether to round the training update 218 up or down. As a non-limiting illustrative example, if a least significant mantissa bit has a value of 4 given a certain exponent value, such that the binary format can only represent integer multiples of 4 (e.g., 4, 8, 12, etc.), and a training update 218 has a value of 11, then stochastic rounding can include determining a difference between the training update 218 and a neighboring integer multiple of a magnitude of the least significant bit (e.g., 11−8=3, etc.); determining a ratio between the difference and the magnitude of the least significant bit

$$( e . g . , \frac{3}{4} = 0.75 ) ;$$

and randomly or pseudorandomly determining whether to round up or down to the nearest multiple of 4 based on the ratio (e.g., with a

$$\frac{3}{4} = 75$$

percent chance of rounding up to 12 and a

$$1 - \frac{3}{4} = 25$$

percent chance of rounding down to 8). Randomly or pseudorandomly determining an action can include, for example, generating a random or pseudorandom number (e.g., between 0 and 1 according to a uniform distribution); and determining, based on a comparison between the generated number and the ratio (e.g., round up if rand (0, 1)<=0.75, etc.), whether to round up or down. In some instances, stochastic rounding can be performed in software, firmware, or hardware (e.g., using a floating-point unit configured to perform stochastic, rather than deterministic rounding, etc.).

In some instances, selecting an eXmY binary format can include selecting based at least in part on one or more expected training conditions (e.g., hyperparameters, etc.) for training the machine-learned model 212. For example, in some instances, a selection of an eXmY binary format can be based at least in part on data indicating whether a machine-learned model 212 will be trained using stochastic rounding or deterministic rounding. For example, in some example experiments according to some aspects of the present disclosure, performing stochastic rounding provided benefits that were approximately equivalent to adding four additional mantissa bits to a selected eXmY binary format. In some instances, selecting an eXmY binary format for training with stochastic rounding can include, for example, identifying a binary format that would be preferred for training with deterministic rounding (e.g., according to methods described above), and reducing the number of mantissa bits by a small number (e.g., 2, 3, 4, 5, 6, etc.). Similarly, selecting an eXmY binary format for training with deterministic rounding can include, for example, identifying a binary format that would be preferred for training with stochastic rounding (e.g., according to methods described above), and increasing the number of mantissa bits by a small number (e.g., 2, 3, 4, 5, 6, etc.).

As another example, in some instances, a selection of an eXmY binary format can be based at least in part on data indicative of a learning rate hyperparameter to be used to train the machine-learned model 212. For example, in some instances, past training data can be obtained, wherein the past training data may be characterized by one or more past learning rate hyperparameters. In some instances, a ratio between a training update 218 and a corresponding persistent parameter to be updated can depend at least in part on a learning rate hyperparameter (e.g., constant learning rate, adaptive learning rate, etc.), such as in instances where a gradient of a loss function is multiplied by the learning rate hyperparameter to determine a training update 218 value. In some instances, a number of mantissa bits for representing the eXmY-formatted persistent parameters 214 when training the machine-learned model 212 can be selected based on training data associated with one or more learning rate hyperparameters that are different from one or more learning rate hyperparameters to be used to train the machine-learned model 212 by performing a learning-rate-adjusted analysis that accounts for a difference in learning rates (e.g., based on a ratio between past and future learning rates, etc.). Accounting for a difference in learning rates can include, for example, dividing each respective past training update 218 values by a respective past learning rate hyperparameter used to generate the respective past training update value 218, and multiplying by a future learning rate hyperparameter to be used to train the machine-learned model 212. After accounting for a change in learning rate hyperparameters, an eXmY binary format can be selected in any manner described above.

In some instances, selecting an eXmY binary format can include selecting one or more scaling or offset values to map one or more subranges of a higher-precision binary format (e.g., IEEE 754 format, etc.) to a range or subrange of a lower-precision binary format. For example, in some instances, selecting an eXmY binary format can include determining, based on training data (e.g., past training data, data indicative of expected future training iterations, etc.), one or more subranges of a higher-precision binary format (e.g., 32-bit float, etc.) to be represented by an eXmY binary format. Selecting the one or more subranges can include, for example, identifying one or more dense subranges of the training data, such as one or more subranges comprising a high percentage of parameter update values (e.g., model update 218 values, etc.) of the training data; one or more subranges comprising a high percentage of parameter values (e.g., eXmY-formatted persistent parameter 214 values, persistent model weight values, etc.); or the like. Selecting a scaling factor can include, for example, comparing a size (e.g., maximum value minus minimum value, etc.) of one or more dense subranges to a size of a range of a candidate eXmY binary format. For example, in some instances, a ratio of a size of the one or more dense subranges to a size of the range of the candidate eXmY binary format can be determined, and a scaling factor can be determined based on the ratio. For example, in some instances, the scaling factor can be approximately equal to the ratio. In some instances, selecting an offset value can include, for example, comparing one or more benchmark values (e.g., maximum, minimum, mean, median, etc.) of the one or more dense subranges to one or more corresponding benchmark values of a range of a candidate eXmY binary format, and selecting an offset value based on the comparison. As a non-limiting illustrative example, in some instances, an offset value can be equal to a difference between a minimum of a dense subrange of a higher-precision format and a minimum of a range of a candidate eXmY binary format; a difference between a maximum and a maximum or between a median and a median; or the like.

In some instances, a plurality of scaling factors or a plurality of offset values can be selected to represent a plurality of distinct subranges (e.g., subranges that are not necessarily continuous with each other; higher-priority and lower-priority subranges represented at different levels of granularity; etc.) using an eXmY binary format. For example, in some instances, a first subrange of a higher-precision format can be mapped to a first subrange of a lower-precision format (e.g., according to methods described above with respect to mapping to a full range of a lower-precision format, etc.); a second subrange of the higher-precision format can be mapped to a second subrange of the lower-precision format; and so on. In some instances, a first mapping and second mapping can have similar (e.g., same) or different scaling factors and similar or different offset values. For example, in some instances, selecting an eXmY binary format can include identifying one or more higher-priority subranges of a higher-precision format to be represented at a higher granularity (e.g., denser subranges associated with a greater number of training data values that fall within the denser subranges, subranges associated with an increased cost associated with similar-magnitude rounding errors, etc.), and one or more lower-priority subranges (e.g., sparser subranges, etc.) to be represented at a lower granularity. In such instances, a scaling factor of the lower-granularity subrange(s) can be larger than a scaling factor of the higher-granularity subrange(s). In some instances, selecting an eXmY binary format can include selecting one or more other relevant properties of the binary format, such as an exponent base (e.g., 2, 10, or another real number, etc.).

In some instances, a precision of some example eXmY binary formats for representing eXmY-formatted persistent parameters 214 can include a precision between 1 and 64 inclusive; such as between 9 and 31 inclusive; such as between 17 and 31 inclusive; such as between 20 and 28 inclusive; such as between 20 and 24 inclusive. For example, in some example experiments according to aspects of the present disclosure, an example machine-learned model 212 was trained using deterministic rounding and eXmY-formatted persistent parameters 214 in an e3m20 format having three exponent bits 104, 20 mantissa bits 106, and one sign bit 102. In the example experiments, the machine-learned model 212 was compared to another machine-learned model trained using an IEEE 754 32-bit floating-point format, and performed similarly according to several metrics (e.g., training loss, BLEU score, ROUGE-2 score, etc.), thereby reducing a computational cost (e.g., memory footprint, memory bandwidth, etc.) of training without a corresponding reduction in quality. Additionally, in some example experiments, a second example machine-learned model 212 was trained using stochastic rounding and eXmY-formatted persistent parameters 214 in an e3m16 format having three exponent bits 104, 16 mantissa bits 106, and one sign bit 102. In the example experiments, the second example machine-learned model 212 performed similarly to the e3m20 deterministic-rounding model and to the IEEE 754 32-bit model, suggesting that stochastic rounding can compensate for an additional reduction in precision of about four mantissa bits, thereby further reducing some computational costs (e.g., memory footprint, memory bandwidth, etc.) associated with training a machine-learned model, without a corresponding reduction in inference output quality.

In some instances, the training method of FIG. 2 can include pretraining or fine-tuning (e.g., supervised fine-tuning, reinforcement learning such as reinforcement learning from human feedback, etc.), such as sequence processing model pretraining using unlabeled data (e.g., using a next-token prediction or masked-token prediction task, etc.), task-specific fine-tuning using task-specific labeled data, or the like.

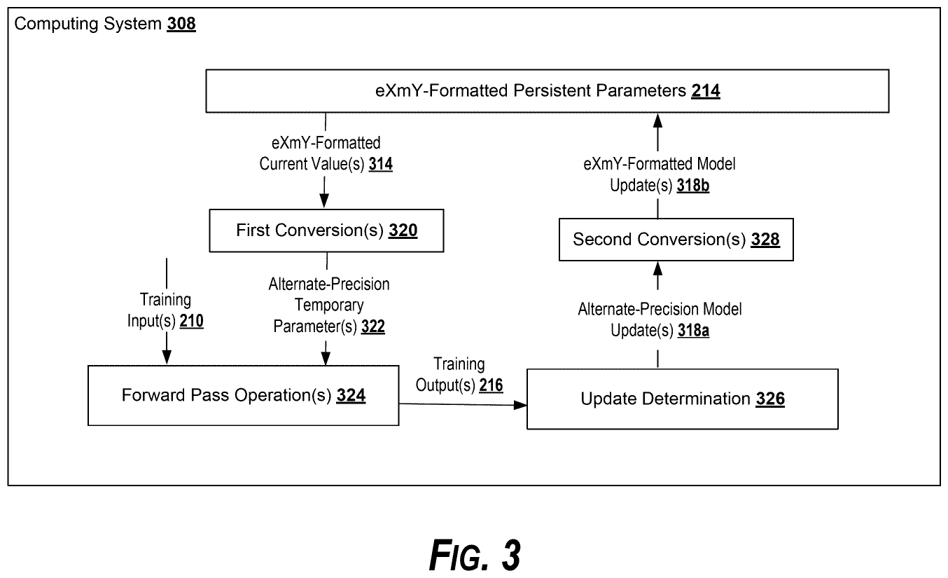

FIG. 3 is a block diagram illustrating an example system for training a machine-learned model using persistent parameters having an eXmY floating-point binary format according to example implementations of aspects of the present disclosure. A computing system 308 can perform one or more first conversions 320 to convert one or more eXmY-formatted current values 314 of one or more eXmY-formatted persistent parameters 214 to one or more alternate-precision temporary parameters 322. The computing system 308 can perform (e.g., using a machine-learned model 212, etc.) one or more forward pass operations 324 using one or more training input(s) 210 and the alternate-precision temporary parameter(s) 322 to generate one or more training outputs 216. Based on the training outputs 216, the computing system 308 can perform an update determination 326 to generate one or more model updates 218, such as alternate-precision model updates 318a having a binary format (e.g., 8-bit floating point, 32-bit floating point, 16-bit float or bfloat, etc.) that is different from an eXmY binary format of the eXmY-formatted persistent parameters 214. In some instances, the computing system 308 can perform one or more second conversions 328 to convert alternate-precision model updates 318a into eXmY-formatted model update(s) 318b having the eXmY binary format of the eXmY-formatted persistent parameters 214. Based on the eXmY-formatted model update(s) 318b, the computing system 308 can update the eXmY-formatted persistent parameters 214.

In some instances, a computing system 308 can be, comprise, be comprised by, or otherwise share one or more properties with a computing system 208. For example, in some instances, a computing system 308 can have any property described herein with respect to a computing system 208, and vice versa.

An eXmY-formatted current value 314 can include, for example, a current value of an eXmY-formatted persistent parameter 214, such as a value of the parameter 214 before an update of the eXmY-formatted persistent parameter 214 (e.g., a value of the eXmY-formatted persistent parameter 214 at the beginning of a training iteration, etc.). In some instances, an eXmY-formatted current value 314 can be, comprise, be comprised by, or otherwise share one or more properties with an eXmY-formatted persistent parameter 214. For example, in some instances, an eXmY-formatted current value 314 can have any property described herein with respect to an eXmY-formatted persistent parameter 214, and vice versa. In some instances, a binary format of the eXmY-formatted current value 314 can have one or more properties described above with respect to FIGS. 1 and 2.

An alternate-precision model update 318a can include, for example, a model update 318 in a binary format that is different from a binary format of an eXmY-formatted persistent parameter 214 being updated. In some instances, a binary format of the alternate-precision model update(s) 318a can be the same as or different from a binary format of the alternate-precision temporary parameters 322.

An eXmY-formatted model update 318b can include, for example, a model update 318 in a binary format that is the same as a binary format of a corresponding eXmY-formatted persistent parameter 214 being updated (e.g., binary format described above with respect to FIG. 1 or 2, etc.).

In some instances, a model update 318 can be, comprise, be comprised by, or otherwise share one or more properties with a model update 218. For example, in some instances, a model update 318 can have any property described herein with respect to a model update 218, and vice versa.

A first conversion 320 can include, for example, an action to convert an eXmY-formatted current value 314 from a first binary format (e.g., binary format of an eXmY-formatted persistent parameter 214, binary format described above with respect to FIG. 1 or 2, etc.) to one or more second binary formats that are different from the first binary format. In some instances, a second binary format can include a binary format having a higher precision (e.g., higher number of mantissa bits 106, exponent bits 104, or both) compared to the first binary format, or a binary format having a lower precision compared to the first binary format. For example, in some instances, a first conversion 320 can include converting an eXmY-formatted current value 314 to a 32-bit floating-point format (e.g., IEEE 754 single-precision floating-point format having 8 exponent bits and 23 mantissa bits, etc.) or converting the eXmY-formatted current value 314 to a lower-precision quantized format (e.g., 8-bit floating-point format, 4-bit integer format, 16-bit IEEE 754 floating-point format, 16-bit “brain” floating point format, etc.). For example, in some instances, a training iteration can include down-converting one or more eXmY-formatted persistent parameters 214 to a lower-precision format (e.g., 4-bit, 8-bit, or 16-bit format, etc.) for performing one or more matrix multiplications; then upconverting a result of the matrix multiplications to another format (e.g., IEEE 754 32-bit floating point format, eXmY format according to FIG. 1 or 2, etc.) to determine one or more model updates 318 based on a result of the matrix multiplication(s). Other implementations are possible.

In some instances, a first conversion 320 can include one or more scaling or offset functions. For example, in some instances, a range of a lower-precision binary format (e.g., eXmY format according to aspects of the present disclosure, IEEE 754 format, quantized format, brain float 16 format, etc.) can be mapped to a subset of a range of a higher-precision binary format (e.g., IEEE 754 format such as 32-bit single-precision floating-point format, etc.) according to one or more scaling or offset values. Scaling and offsetting can include, for example, multiplying a first-precision value (e.g., lower-precision parameter value, higher-precision parameter value, etc.) by one or more scaling factors to obtain one or more scaled values (e.g., scaled parameters, etc.); and adding an offset value to the scaled value to generate an offset scaled value. As a non-limiting illustrative example, if a reduced-precision binary format can represent values between 0 and 100 inclusive, and a higher-precision binary format can represent values between 0 and one million inclusive, then the reduced-precision binary format can be mapped to a subset of the higher-precision format comprising values between 100,000 and 200,000 by scaling the reduced-precision values according to a scaling factor of 1,000; and offsetting the scaled values by an offset value of 100,000. In some instances, a scaling value, offset value, or subset of a higher-precision range can be determined during selection of an eXmY binary format for representing the eXmY-formatted persistent parameters 214. Further details of some example implementations for determining scaling values, offset values, or ranges of interest according to some aspects of the present disclosure are described herein with respect to FIGS. 2 and 4.

In some instances, a first conversion 320 can include a uniform or non-uniform mapping of lower-precision values to higher-precision values. For example, in some instances, a non-uniform mapping can include a mapping comprising a plurality of scaling values, a plurality of offset values, or both, which can be associated with a plurality of subranges of a range of values represented by a lower-precision format. Other examples are possible.

In some instances, a first conversion 320 can be performed using one or more software, firmware, or hardware components configured to receive an eXmY-formatted value in a binary format according to FIG. 1 or 2 and output a corresponding value in another binary format, such as an IEEE 754 binary format, an 8-bit or lower-precision quantized format; another binary format used in machine learning, such as brain float 16 or TensorFloat 32; or other binary format. In some instances, a hardware component for performing a first conversion 320 can include a floating-point unit configured to receive an eXmY-formatted value in a binary format according to FIG. 1 or 2 and output a corresponding value in another binary format (e.g., with or without scaling or offsetting the value, etc.).

An alternate-precision temporary parameter 322 can include, for example, a temporary variable represented in a binary format that is different from a format of the eXmY-formatted persistent parameters 214, wherein a value of the temporary variable is equivalent to a value of a corresponding eXmY-formatted current value 314 used to generate the alternate-precision temporary parameter 322. Some example binary formats for an alternate-precision temporary parameter 322 can include, for example, an IEEE 754 floating-point format (e.g., 16-bit, 32-bit, or 64-bit format); a quantized format (e.g., 16-bit brain floating-point format, 8-bit, 4-bit, 2-bit, or 1-bit quantized format; quantized integer or floating-point format; etc.); a format having a precision that is an integer power of two; or other binary format.

Forward pass operation(s) 324 can include, for example, operations to generate training output(s) 216 based on training input(s) 210 and alternate-precision temporary parameter(s) 322. For example, a forward pass operation 324 can include providing a training input 210 to a machine-learned model 212; and generating, by the machine-learned model 212 (e.g., using first conversion(s) 320 or alternate-precision temporary parameter(s) 322, etc.), a training output 216 based on the training input.

An update determination 326 can include, for example, any process for determining a model update 318, such as evaluating a training output 216 (e.g., based on an objective function; based on a comparison to a ground truth output; etc.) and determining a model update 318 based on the training output 216 (e.g., by backpropagating a gradient of the loss function, etc.).

A second conversion 328 can include, for example, an action to convert an alternate-precision model update 318a from a first binary format (e.g., IEEE 754 format, quantized format, etc.) to one or more second binary formats (e.g., binary format of an eXmY-formatted persistent parameter 214, binary format described above with respect to FIG. 1 or 2, etc.) different from the first binary format. In some instances, a first binary format (e.g., source format, etc.) of the second conversion 328 can be the same as or different from a second binary format (e.g., destination format, etc.) of a corresponding first conversion 320 (e.g., first conversion 320 associated with a same training iteration, same eXmY-formatted persistent parameter 214, or the like). In some instances, a second conversion 328 can have any property described herein with respect to a first conversion 320. For example, a second conversion 328 can include one or more scaling or offset functions (e.g., scaling or offset functions that may be an inverse of a scaling or offset function of a corresponding first conversion 320, etc.); may be performed using software, firmware, or hardware components (e.g., FPU configured to perform conversion(s), etc.); or other property described herein with respect to a first conversion 320.

FIG. 4 is a block diagram illustrating an example system for training a machine-learned model using optimizer parameters having an eXmY floating-point binary format according to example implementations of aspects of the present disclosure. A computing system 408 storing a plurality of eXmY-formatted optimizer parameters 430 can provide one or more training inputs 210 to a machine-learned model 212. The machine-learned model 212 can generate, based at least in part on the training inputs 210, one or more training outputs 216. The computing system 408 can perform an optimizer parameter determination 432 based on the training output(s) 216 to generate one or more optimizer parameter update values 434, and the computing system can update the eXmY-formatted optimizer parameters 430 according to the optimizer update values 434. Based on the updated optimizer parameters 436, the computing system 408 can perform a model update determination 438 to determine one or more model updates 418 for the machine-learned model 212.

In some instances, a computing system 408 can be, comprise, be comprised by, or otherwise share one or more properties with a computing system 208, 308. For example, in some instances, a computing system 408 can have any property described herein with respect to a computing system 208, 308, and vice versa. For example, in some instances, generating model updates 218 based on training inputs 210 can include any operation described above with respect to FIG. 2 or 3 (e.g., first conversion(s) 320, second conversion(s) 328, etc.).

In some instances, a model update 418 can be, comprise, be comprised by, or otherwise share one or more properties with a model update 218, 318. For example, in some instances, a model update 418 can have any property described herein with respect to a model update 218, 318, and vice versa.

An eXmY-formatted optimizer parameter 430 can include, for example, a parameter represented in a binary format having X exponent bits 104, Y mantissa bits 106, and zero or more (e.g., one) sign bits 102. In some instances, a binary format of an eXmY-formatted optimizer parameter 430 can have a precision that is not an integer power of two. For example, in some instances, a binary format of an eXmY-formatted optimizer parameter can have a precision between 5 and 7 bits inclusive, such as 6 bits. Other precisions are possible (e.g., 9 to 15 bits such as about 12 bits; 17 to 31 bits; integer powers of two, etc.).

In some instances, an optimizer parameter 430 (e.g., optimizer variable, etc.) can include a parameter that is used in one or more steps of a training iteration for training a machine-learned model 212 (e.g., as depicted in FIG. 2, etc.), such as a momentum parameter for determining one or more adaptive learning rates, or other optimizer parameter. In some instances, an optimizer parameter 430 can include any parameter used in an optimization method for training a machine-learned model 212, such as AdaGrad, RMSProp, Adam and Adam-derived optimizers (e.g., Adadelta, AdamW, Adamax, etc.), or other optimization method. In some instances, an eXmY-formatted optimizer parameter 430 can include any parameter used in training a machine-learned model 212 that is not a parameter of the machine-learned model 212 itself (e.g., hyperparameters, intermediate parameters used to determine an adaptive learning rate, etc.).

In some instances, a plurality of eXmY-formatted optimizer parameters 430 can include a plurality of per-parameter optimization values (e.g., optimization values associated with a plurality of per-parameter adaptive learning rates, etc.), such as a separate optimizer parameter 430 for each parameter 214 of a machine-learned model 212. In some instances, a plurality of per-parameter optimization values can be stored in a data structure having the same dimension(s) as a data structure comprising the eXmY-formatted persistent parameters 214, such as a tensor having the same length, width, height, or other dimension. For example, in some instances, a plurality of optimizer parameters 430 can include a plurality of per-parameter adaptive learning rates, or a plurality of per-parameter intermediate optimizer parameters 430 used to determine a plurality of per-parameter adaptive learning rates. As a non-limiting illustrative example, in some instances, an optimization method can include an Adaptive Moment Estimation (Adam) method or modified Adam method (e.g., Adadelta, AdamW, Adamax, AMSGrad, NAdam, etc.) using a plurality of optimizer parameters 430 comprising a plurality of per-parameter 214 first moment values; a plurality of per-parameter second moment values; or other optimizer parameters 430. In some instances, a first moment can include an exponential moving average of a plurality of gradients associated with a plurality of training iterations of a training process. A second moment can include, for example, an exponential moving average of a plurality of squares of gradients. Determining an exponential moving average at a particular training iteration can include, for example, multiplying a prior exponential moving average from a prior training iteration by a decay parameter (e.g., 0.9, 0.99, Adam β₁ or β₂, etc.); multiplying a new value associated with the current training iteration (e.g., gradient, squared gradient, etc.) by one minus the decay parameter; and adding the products together. In some instances, an optimization method can include determining a plurality of per-parameter adaptive learning rates based on a plurality of per-parameter exponential moving averages, and determining one or more training updates 218 based on the per-parameter adaptive learning rates. Other implementations are possible.

An optimizer parameter determination 432 can include, for example, any method for determining one or more values (e.g., current value, updated value, adjustment value, etc.) associated with one or more eXmY-formatted optimizer parameters 430 based on one or more training outputs 216. For example, in some instances, an example optimizer parameter determination 432 can include any method for determining an optimizer update value 434 for an optimization method such as Adam or its derivatives. Other examples are possible.

An optimizer variable update value 434 can include, for example, an adjustment value to adjust (e.g., add to, subtract from, multiply, etc.) an eXmY-formatted optimizer parameter 430; a substitute value or updated value to replace an eXmY-formatted optimizer parameter 430; or other appropriate update value. In some instances, an optimizer update value 434 can include a value in a binary format that is the same as or different from a binary format of the eXmY-formatted optimizer parameter 430 being updated.

An updated optimizer parameter 436 can include, for example, an updated value associated with an eXmY-formatted optimizer parameter 430 (e.g., after an optimizer update value 434 has been applied for a current training iteration, etc.). In some instances, an updated optimizer parameter 436 can include a value in a binary format that is the same as or different from a binary format of the eXmY-formatted optimizer parameter 430 being updated, such as a binary format described herein with respect to an alternate-precision temporary parameter 322.

A model update determination 438 can include, for example, any method for determining a value for a model update 418 based on one or more of: updated optimizer parameter(s) 436; training output(s) 216; one or more objective functions for evaluating the training output(s) 216; ground truth output(s) to compare to the training output(s) 216; or the like.

In some instances, one or more of an optimizer parameter determination 432 and a model update determination 438 can include one or more conversions (e.g., first conversion 320, second conversion 328, etc.). For example, in some instances, one or more optimizer parameters 430 can be stored in an eXmY binary format, and can be converted (e.g., according to a first conversion 320, etc.) to an alternative binary format (e.g., 32-bit floating-point format, etc.) before being used in an optimizer parameter determination; before being used in a model update determination 438; or both. For example, in some instances, determining a model update 418 based on a training output 216 can include converting one or more eXmY-formatted optimizer parameters 430 to a first alternate binary format; determining one or more optimizer update values 434 using the converted parameters in the first alternate binary format; determining one or more updated parameters 436 in the first alternate binary format; and determining one or more model updates 418 in the first or a second alternate binary format. Continuing the example, in some instances, the updated parameters 436 can be converted (e.g., according to a second conversion 328, etc.) to an eXmY format and stored as eXmY-formatted optimizer parameters 430 for use in one or more future training iterations. Other examples are possible.

In some instances, an eXmY binary format for representing (e.g., storing, transmitting, performing computations with, etc.) eXmY-formatted optimizer parameters 430 can be selected in any manner described herein (e.g., above with respect to FIG. 2, etc.) with respect to selecting an eXmY binary format for representing eXmY-formatted persistent parameters 214, with appropriate substitutions (e.g., statistical distribution of ratios of first term and second term of an equation associated with an optimizer parameter determination 432 instead of ratio of parameter 214 to training update 218, such as a ratio of β₁*m to (1−β1)*g, where g is a gradient associated with a current training iteration and m is a most recent value of an eXmY-formatted optimizer parameter 430; Adam β₁ or β₂ or other hyperparameter proportional to an expected ratio between eXmY-formatted optimizer parameter(s) 430 and optimizer parameter update values 434 instead of a learning rate hyperparameter; etc.). For example, in some instances, a number of mantissa bits can be selected based on training data (e.g., past training data, expected future training data, etc.) indicative of a statistical distribution of ratios between optimizer update values 434 and corresponding eXmY-formatted optimizer parameters 430 being updated or based on data indicative of a statistical distribution of rounding losses attributable to a lack of mantissa bits; a number of exponent bits can be selected based on a ratio of a maximum value of a plurality of eXmY-formatted optimizer parameters 430 to a minimum value (e.g., minimum eXmY-formatted optimizer parameters 430 value, minimum optimizer update value 434, etc.) or based on data indicative of a distribution of rounding losses attributable to a lack of exponent bits; a number of mantissa bits can be adjusted based on whether the eXmY-formatted optimizer parameters 430 will be updated using stochastic rounding or deterministic rounding; a scaling or offset value can be determined based on a mapping of a range of values represented by lower-precision binary format to a subrange of a higher-precision binary format; a binary format can be selected from a plurality of candidate binary formats based on one or more thresholds (e.g., percentage thresholds, magnitude thresholds, etc.), computational resource budgets (e.g., hardware resource budgets, etc.), or the like; or other action described above with respect to FIG. 2 and eXmY-formatted persistent parameters 214.

In some example experiments according to some aspects of the present disclosure, eXmY binary formats for representing eXmY-formatted optimizer parameters 430 were tested using an Adam optimization method, with β₁=0.9, and β₂ between 0.95 and 0.999 inclusive. In training data associated with the example experiments, a distribution of ratios of a first term to a second term of an equation for determining an updated Adam optimizer value (e.g., β₁*m+(1−β₁)*g, etc.) ranged from approximately [2⁻²⁴, 2⁻¹], indicating that 24 bits of mantissa may be required to capture all updates. However, in the distribution, 99.3 percent of updates had a ratio in the range [2⁻⁸, 2⁻¹], indicating that 8 bits of mantissa may be sufficient to represent the eXmY-formatted optimizer parameters 430 with minimal rounding loss or quantization error. Additionally, in the distribution, 88.9 percent of updates would be captured by 4 bits of mantissa; 78.3 percent of updates by 3 bits of mantissa; and 59.6 percent of updates by 2 bits of mantissa.

In the training data associated with the example experiments, a range of exponent values of a plurality of Adam first-moment optimizer parameters ranged from 82 to 114, a difference of about 32. A 32-value range can be fully represented, for example, using five exponent bits (e.g., because 25=32). However, less than about 1 percent of exponent values in the example data were less than 100. If values with exponents below 100 are treated as zero, then the remaining exponent range [100, 114] can be represented in four bits. In some instances, additional techniques can be used to reduce an exponent range to less than or equal to eight values, reducing the required number of exponent bits to three. Example techniques can include performing blockwise quantization with a small block size; using the extended dynamic range provided by subnormal floating-point representations; or other techniques.

In the example experiments, a plurality of candidate binary formats for representing the eXmY-formatted optimizer parameters 430 were tested, including an e3m2 format (i.e., binary format having 3 exponent bits and 2 mantissa bits), an e3m4 binary format, an e3m8 binary format, an e3 ml binary format, an e4m3 binary format, and a baseline format using an IEEE 754 32-bit floating point format to represent the optimizer parameters. In the example experiments, all formats tested other than e3 ml achieved training losses, BLEU scores, and ROUGE-2 scores at each training step that were not significantly different from the baseline 32-bit representation. This may suggest that a number of mantissa bits sufficient to capture about 60 percent of optimizer parameter updates may be sufficient to achieve training results equivalent to training with a 32-bit representation.

In some instances, performing an optimizer parameter determination 432 or model update determination 438 can include, for example, one or more conversion operations such as a conversion operation described above with respect to FIG. 3. For example, in some instances, a current value of eXmY-formatted optimizer parameter 430 having a first binary format can be converted to a second binary format (e.g., IEEE 754 format, etc.); an optimizer update value 434, updated parameter 436, or model update 418 can be determined in the second binary format or a third binary format; and an updated parameter 436 or optimizer update value 434 can be converted to the first binary format to enable storage of an updated eXmY-formatted optimizer parameter 430 in the first binary format. In some instances, converting from a first binary format to a second binary format can include scaling, offsetting, or other method described above with respect to first conversion(s) 320 or second conversion(s) 328.

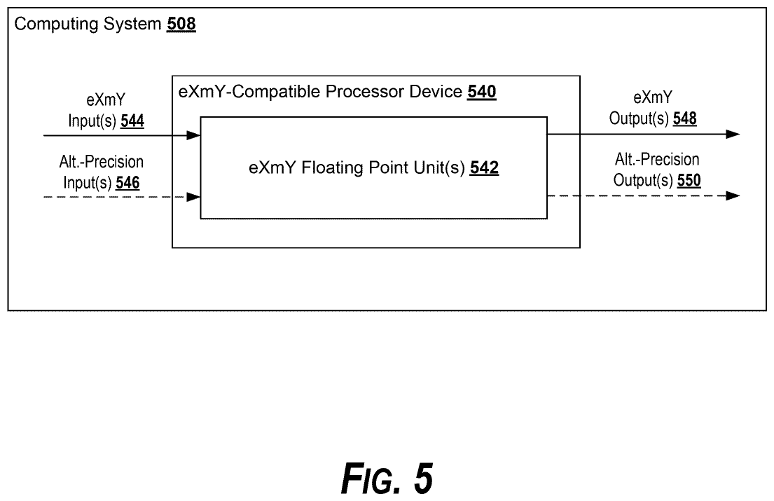

FIG. 5 is a block diagram illustrating an example computing system 508 comprising an eXmY-compatible processor device 540 for performing floating-point operations based on an eXmY floating-point binary format according to example implementations of aspects of the present disclosure. An eXmY-compatible processor device 540 can receive eXmY-formatted input(s) 544 and generate eXmY-formatted output(s) 548 or alternate-precision output(s) 550 based on the eXmY input(s) 544. Additionally or alternatively, the eXmY-compatible processor device 540 can receive alternate-precision input(s) 546 and generate eXmY-formatted output(s) 548 or alternate-precision output(s) 550 based on the eXmY input(s) 544.

In some instances, a computing system 508 can be, comprise, be comprised by, or otherwise share one or more properties with a computing system 208, 308, 408. For example, in some instances, a computing system 508 can have any property described herein with respect to a computing system 208, 308, 408, and vice versa.

An eXmY-compatible processor device 540 can include, for example, any suitable device for performing processing functions for a computing device (e.g., a processor core, a microprocessor, an ASIC, an FPGA, a controller, a microcontroller, etc.). In some instances, an eXmY-compatible processor device 540 can include one or more (e.g., a plurality of, etc.) floating-point units 542. In some instances, an eXmY-compatible processor device 540 can include one or more other components, such as memory components, registers, programmable logic devices, floating-point units that may not be configured to process a binary format of an eXmY-formatted persistent parameter 214 (e.g., IEEE 754 standard floating-point units, etc.), matrix multiplication units, systolic arrays, or other hardware components.

An eXmY floating point unit 542 can include, for example, one or more hardware devices configured to perform operations using eXmY input(s) 544 as input; operations generating eXmY outputs 548 as output; or both. In some instances, example operations performed by an eXmY floating-point unit 542 can include conversion operations (e.g., first conversion(s) 320 or second conversion(s) 328 as described above with respect to FIG. 3, etc.), such as converting an eXmY input 544 representing a first value in a first binary format (e.g., eXmY binary format described above with respect to FIG. 1 or 2, etc.) to an alternate-precision output 550 that represents the first value in a second binary format (e.g., IEEE 754 standard format, quantized format, etc.); converting an alternate-precision input 546 representing a first value in a first binary format (e.g., IEEE 754 standard format, quantized format, etc.) to an eXmY output 548 representing the first value in a second binary format (e.g., eXmY binary format described above with respect to FIG. 1 or 2, etc.). In some instances, an eXmY floating point unit 542 can include hardware configured to perform floating-point operations natively in an eXmY format described with respect to FIG. 2, such as addition or multiplication operations that receive two or more eXmY inputs 544 as input, and generate one or more eXmY outputs 548 as output. As a non-limiting illustrative example, an eXmY-compatible floating point unit 542 can be configured to perform addition operations, such as operations adding an eXmY-formatted persistent parameter 214 to a model update 218 having a binary format that is the same as a binary format of the eXmY-formatted persistent parameter, without converting either value 214, 218 to a different binary format. Other implementations are possible.

Additionally, in some instances, an eXmY floating point unit can be configured to perform operations receiving alternate-precision input(s) 546 and generating alternate-precision output(s) 550 based on the alternate-precision input(s) 546 without deviating from the scope of the present disclosure.

In some instances, an eXmY floating point unit 542 or eXmY-compatible processor device 540 can be configured to perform operations (e.g., conversion operations, arithmetic operations, etc.) using only one eXmY format (e.g., e3m16, e3m20, etc.) having a precision that is not an integer power of two (e.g., in addition to one or more IEEE 754 formats, etc.), or can be configured to work with a plurality of different nonstandard formats. For example, in some instances, an eXmY floating point unit 542 can include programmable logic (e.g., multiplexer, field programmable gate array, etc.) to perform operations (e.g., conversions, arithmetic, etc.) using different eXmY binary formats (e.g., based on a selection signal indicative of a binary format for the operations; based on a register storing a value indicative of a binary format for the operations; etc.). Other implementations are possible. An eXmY floating point unit 542 or eXmY-compatible processor device 540 configured to work with multiple binary formats can be configured to work with any set of binary formats, such as all possible eXmY binary formats having a precision less than or equal to 32, or any subset of the possible eXmY binary formats (e.g., binary formats having between 2 and 6 exponent bits or some subset thereof, such as binary formats having exactly 3 exponent bits; binary formats having a number of mantissa bits between 3 and 20 or some subset thereof; etc.).

In some instances, an eXmY floating point unit 542 can include hardware configured to perform scaling and offsetting when converting from a first binary format to a second binary format. For example, in some instances, an eXmY floating point unit 542 can include one or more hardware components (e.g., registers, etc.) configured to store or otherwise obtain (e.g., receive, etc.) a scaling value, an offset value, or both; and one or more hardware components configured to perform a conversion (e.g., as described above with respect to FIG. 3) from a first binary format to a second binary format based on the scaling or offset values. A conversion can include, for example, a conversion from an eXmY input 544 to an alternate-precision output 550; a conversion from an alternate-precision input 546 to an eXmY output 548; or another conversion between binary formats.

In some instances, an eXmY floating point unit 542 or eXmY-compatible processor device 540 can include one or more hardware components configured to perform stochastic rounding, such as hardware components configured to randomly or pseudorandomly determine whether to round up or round down based on a magnitude of a remainder (e.g., a value to be added that is smaller than a least significant bit of an eXmY-formatted persistent parameter 214, etc.) associated with a floating-point operation performed by eXmY-compatible processor device 540. For example, in some instances, an eXmY floating point unit 542 or eXmY-compatible processor device 540 can include one or more hardware random number generators, hardware pseudorandom number generators, or both; hardware configured to generate a pseudorandom selection signal or to perform a pseudorandom programmable logic operation (e.g., branching operation, etc.); or other stochastic rounding hardware.

An eXmY input 544 or eXmY output 548 can include, for example, an input or output value having an eXmY binary format having one or more properties described above with respect to FIGS. 1-4, such as a binary format of an eXmY-formatted persistent parameter 214, eXmY-formatted optimizer parameter 430, eXmY-formatted model update 318b, or the like.

An alternate-precision input 546 or alternate-precision output 550 can include, for example, an input or output value having a binary format that is different from a corresponding eXmY input 544 or eXmY output 548 associated with the same operation. In some instances, an alternate precision input 546 or alternate-precision output 550 can include an IEEE 754 standard format (e.g., 32-bit floating point, etc.) or other format (e.g., brain float 16, 8-bit floating point, 4-bit or lower-precision quantized format, etc.) having one or more properties (e.g., a precision that is an integer power of two, etc.) that are different from one or more properties described above with respect to FIGS. 1-4 (e.g., with respect to an eXmY-formatted persistent parameter 214, eXmY-formatted optimizer parameter 430, eXmY-formatted model update 318b, etc.).

However, in some instances, an alternate precision input 546 or alternate-precision output 550 can include a binary format described above with respect to FIGS. 1-4 without deviating from the scope of the present disclosure. For example, in some instances, an eXmY floating point unit 542 can convert from a first eXmY binary format having a precision that is not an integer power of two to a second, different eXmY binary format having a precision that is not an integer power of two without deviating from the scope of the present disclosure.

### Example Methods

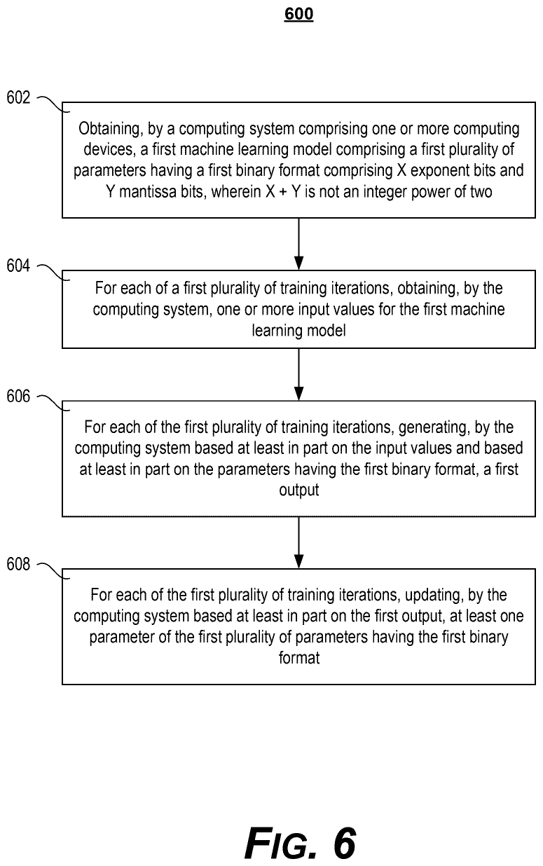

FIG. 6 depicts a flowchart diagram of an example method for training a machine-learned model according to example embodiments of the present disclosure. Although FIG. 6 depicts steps performed in a particular order for purposes of illustration and discussion, the methods of the present disclosure are not limited to the particularly illustrated order or arrangement. The various steps of example method 600 can be omitted, rearranged, combined, and/or adapted in various ways without deviating from the scope of the present disclosure.

At 602, example method 600 can include obtaining, by a computing system (e.g., computing system 208) comprising one or more computing devices, a first machine learning model (e.g., machine-learned model 212) comprising a first plurality of parameters having a first binary format comprising X exponent bits and Y mantissa bits, wherein X+Y is not an integer power of two (e.g., eXmY-formatted persistent parameters 214). In some instances, example method 600 at 602 can include using one or more systems or performing one or more activities described with respect to FIG. 2.

At 604, example method 600 can include, for each of a first plurality of training iterations, obtaining, by the computing system, one or more input values (e.g., training inputs 210, etc.) for the first machine learning model. In some instances, example method 600 at 604 can include using one or more systems or performing one or more activities described with respect to FIG. 2.

At 606, example method 600 can include, for each of the first plurality of training iterations, generating, by the computing system based at least in part on the one or more input values and based at least in part on the parameters having the first binary format, a first output (e.g., training output 216, etc.). In some instances, example method 600 at 606 can include using one or more systems or performing one or more activities described with respect to FIG. 2.

At 608, example method 600 can include, for each of the first plurality of training iterations, updating, by the computing system based at least in part on the first output, at least one parameter of the first plurality of parameters having the first binary format. In some instances, example method 600 at 608 can include using one or more systems or performing one or more activities described with respect to FIG. 2.

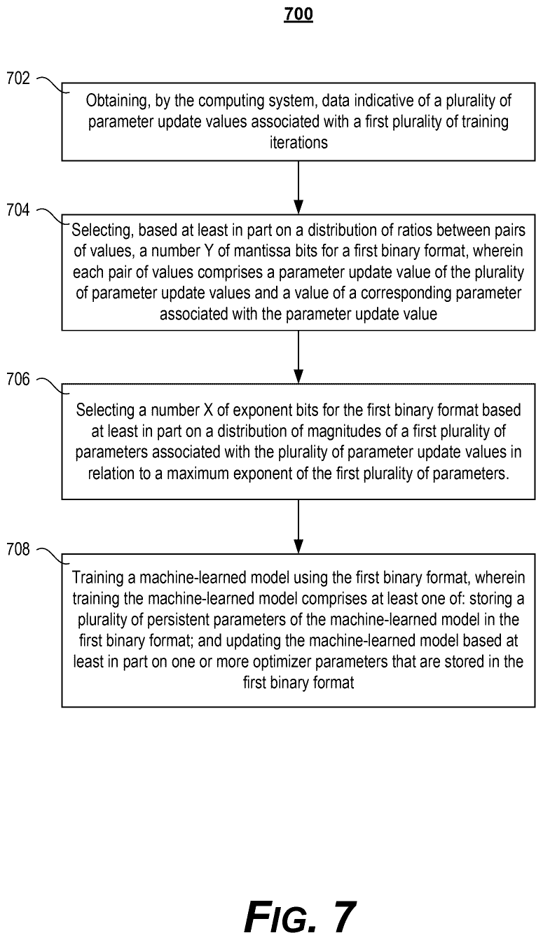

FIG. 7 depicts a flowchart diagram of an example method for selecting an eXmY binary format according to example embodiments of the present disclosure. Although FIG. 7 depicts steps performed in a particular order for purposes of illustration and discussion, the methods of the present disclosure are not limited to the particularly illustrated order or arrangement. The various steps of example method 700 can be omitted, rearranged, combined, and/or adapted in various ways without deviating from the scope of the present disclosure.

At 702, example method 700 can include obtaining, by a computing system (e.g., computing system 208, etc.), data indicative of a plurality of parameter update values associated with a first plurality of training iterations. In some instances, example method 700 at 702 can include using one or more systems or performing one or more activities described with respect to FIG. 2.

At 704, example method 700 can include selecting, based at least in part on a distribution of ratios between pairs of values, a number Y of mantissa bits for a first binary format, wherein each pair of values comprises a parameter update value of the plurality of parameter update values and a value of a corresponding parameter associated with the parameter update value. In some instances, example method 700 at 704 can include using one or more systems or performing one or more activities described with respect to FIG. 2 or 4.

At 706, example method 700 can include selecting a number X of exponent bits for the first binary format based at least in part on a distribution of magnitudes of a first plurality of parameters associated with the plurality of parameter update values in relation to a maximum exponent of the first plurality of parameters. In some instances, example method 700 at 706 can include using one or more systems or performing one or more activities described with respect to FIG. 2 or 4.

At 708, example method 700 can include training a machine-learned model (e.g., machine-learned model 212) using the first binary format, wherein training the machine-learned model comprises at least one of: storing a plurality of persistent parameters (e.g., eXmY-formatted persistent parameters 214, etc.) of the machine-learned model in the first binary format; and updating the machine-learned model based at least in part on one or more optimizer parameters (e.g., eXmY-formatted optimizer parameters 430, etc.) that are stored in the first binary format. In some instances, example method 700 at 708 can include using one or more systems or performing one or more activities described with respect to FIG. 2 or 4.

FIG. 8 depicts a flowchart of a method 800 for training one or more machine-learned models according to aspects of the present disclosure. For instance, an example machine-learned model can include a machine-learned model 212.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), chemical or biochemical data, image data, audio data, audiovisual data, haptic data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and astronomical data, sensor data and chemical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

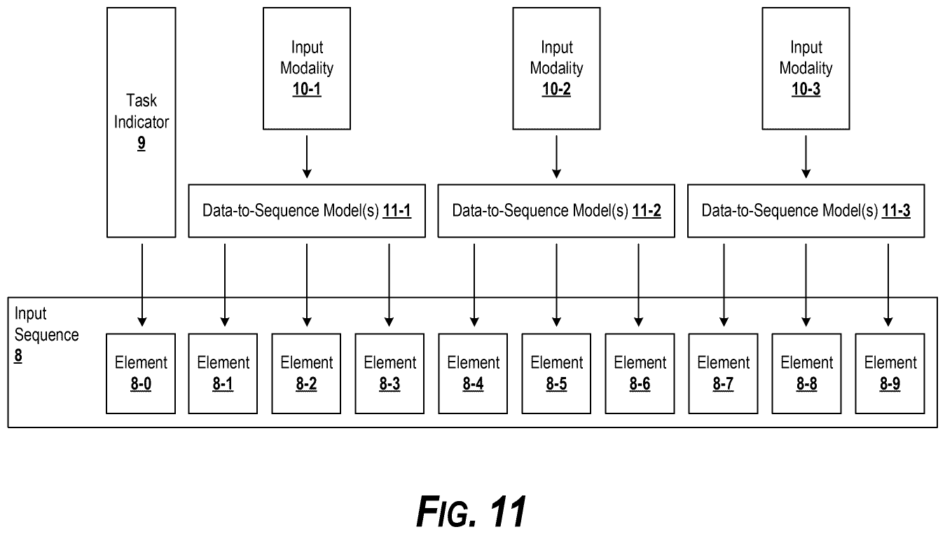

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

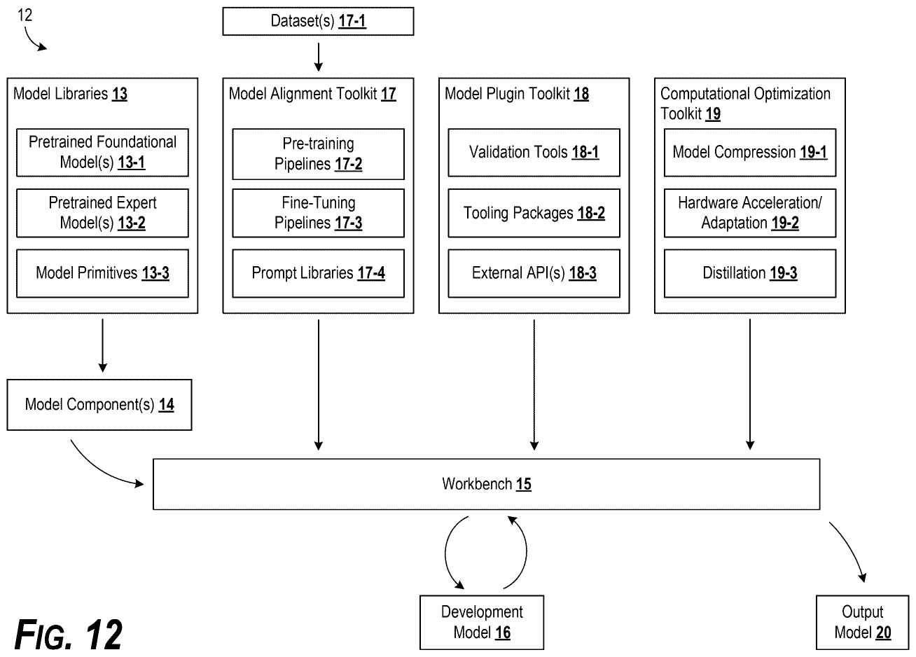

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

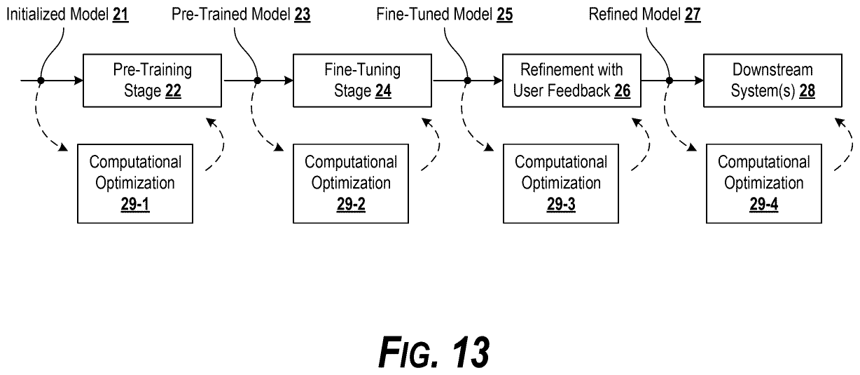

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

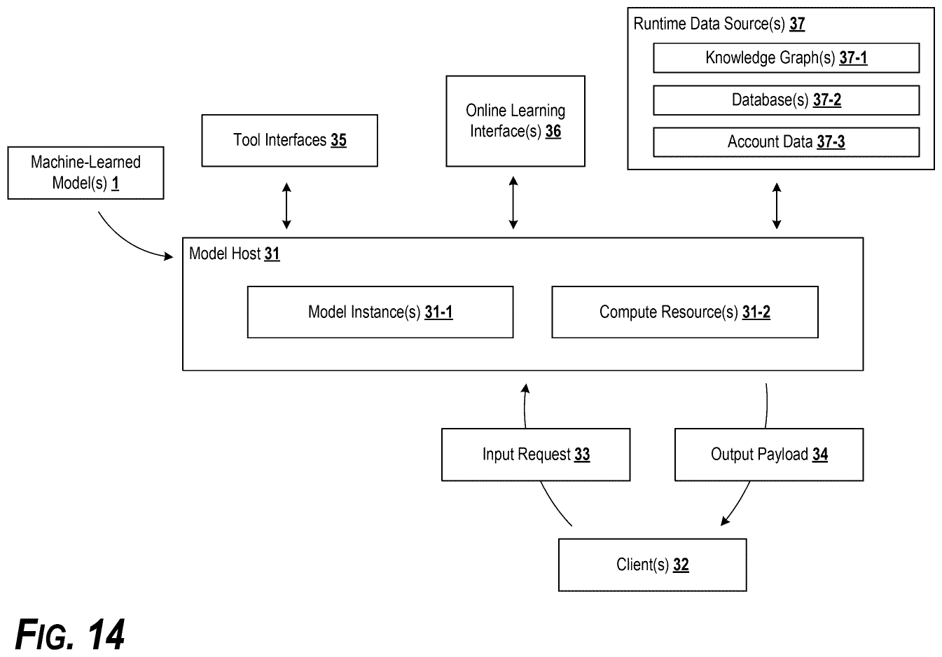

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

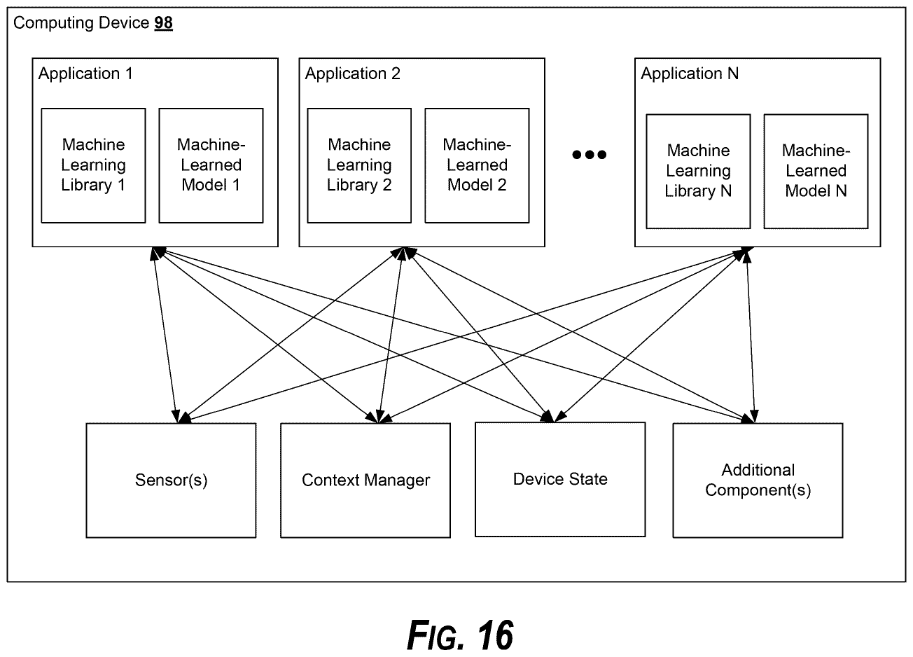

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

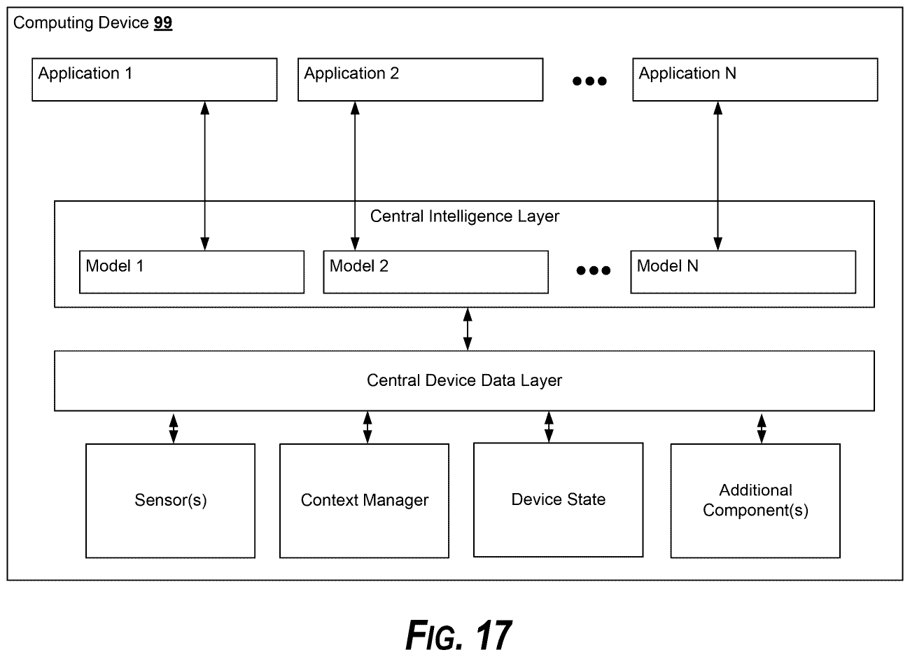

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method, comprising:
obtaining, by a computing system comprising one or more computing devices, a first machine learning model comprising a first plurality of parameters having a first binary format comprising X exponent bits and Y mantissa bits, wherein a precision of the first binary format is not an integer power of two; and
for each of a first plurality of training iterations:
obtaining, by the computing system, one or more input values for the first machine learning model;
generating, by the computing system based at least in part on the one or more input values and based at least in part on the parameters having the first binary format, a first output; and
updating, by the computing system based at least in part on the first output, at least one parameter of the first plurality of parameters having the first binary format.

2. The method of claim 1, wherein the precision of the first binary format is between 9 and 31 inclusive.

3. The method of claim 1, further comprising:
obtaining, by the computing system, data indicative of a plurality of parameter update values associated with a second plurality of training iterations, wherein the second plurality of training iterations is performed before the first plurality of training iterations; and
selecting, based at least in part on the plurality of parameter update values, the first binary format.

4. The method of claim 3, wherein selecting the first binary format comprises selecting, based at least in part on a distribution of ratios between pairs of values, a value for Y, wherein each pair of values comprises a parameter update value of the plurality of parameter update values and a value of a corresponding parameter associated with the parameter update value.

5. The method of claim 3, wherein selecting the first binary format comprises selecting a value for X based at least in part on a distribution of magnitudes of the first plurality of parameters or a second plurality of parameters in relation to a maximum exponent of the first plurality of parameters or the second plurality of parameters.

6. The method of claim 1, wherein updating the at least one parameter comprises:
determining, by the computing system prior to updating, whether a first value of one or more bits of an update value for the at least one parameter is smaller than a second value of a least significant bit of the at least one parameter; and
performing, by the computing system responsive to determining that the first value of the one or more bits of the update value for the at least one parameter is smaller than the second value of the least significant bit of the at least one parameter, a stochastic rounding operation.

7. The method of claim 1, wherein updating the at least one parameter comprises determining, based at least in part on one or more optimizer variables having the first binary format or a second binary format with N exponent bits and Q mantissa bits wherein N+Q+1 is not an integer power of two, an update value for the at least one parameter, and further comprising:
for each of the first plurality of training iterations:
updating, by the computing system based at least in part on the first output, at least one of the one or more optimizer variables.

8. The method of claim 7, wherein the one or more optimizer variables comprise one or more exponential moving averages associated with one or more gradients of an objective function.

9. The method of claim 7, further comprising:
obtaining data indicative of a plurality of optimizer variable update values for the optimizer variables during a second plurality of training iterations, wherein the second plurality of training iterations was performed before the first plurality of training iterations; and
selecting, based at least in part on the plurality of optimizer variable update values, the second binary format.

10. The method of claim 9, wherein selecting the second binary format comprises selecting, based at least in part on a distribution of ratios between pairs of values, a value for Q, wherein each pair of values comprises an optimizer variable update value and a value of a corresponding optimizer variable associated with the optimizer variable update value.

11. The method of claim 9, wherein selecting the second binary format comprises selecting a value for N based at least in part on a distribution of magnitudes of the one or more optimizer variables during the second plurality of training iterations in relation to a maximum exponent associated with the one or more optimizer variables.

12. The method of claim 1, further comprising:
converting, by the computing system prior to updating the at least one parameter, the at least one parameter to a second binary format having a higher precision than the first binary format to generate at least one higher-precision parameter;
wherein updating the at least one parameter comprises:
updating the at least one higher-precision parameter; and
converting the higher-precision parameter to the first binary format.

13. The method of claim 1, wherein converting the at least one parameter comprises:
multiplying, by the computing system, the at least one parameter by one or more scaling factors to generate a scaled parameter; and
adding, by the computing system, an offset value to the scaled parameter.

14. The method of claim 1, further comprising:
converting, by the computing system prior to generating the first output, the at least one parameter to a second binary format having a lower precision than the first binary format to generate at least one lower-precision parameter;
wherein generating the first output comprises performing at least one matrix multiplication using the at least one lower-precision parameter.

15. A processor device comprising:
one or more floating-point units configured to perform one or more floating-point operations using a first binary format comprising X exponent bits and Y mantissa bits, wherein a precision of the first binary format is not an integer power of two.

16. The processor device of claim 15, wherein the one or more floating-point operations comprise converting from the first binary format to a second binary format comprising J exponent bits and K mantissa bits, wherein J+K is different from X+Y.

17. The processor device of claim 15, wherein the one or more floating-point units are configured to perform floating-point operations associated with a plurality of binary formats comprising at least the first binary format and a second binary format, the second binary format having a total number of bits between 17 and 31 inclusive.

18. The processor device of claim 15, wherein the one or more floating-point units are configured to perform stochastic rounding.

19. A computing system comprising one or more processors and one or more non-transitory computer-readable media storing instructions that are executable by one or more processors to cause the computing system to perform operations, the operations comprising:
obtaining a first machine learning model comprising a first plurality of parameters having a first binary format comprising X exponent bits and Y mantissa bits, wherein a precision of the first binary format is not an integer power of two; and
for each of a first plurality of training iterations:
obtaining one or more input values for the first machine learning model;
generating, based at least in part on the one or more input values and based at least in part on the parameters having the first binary format, a first output; and
updating, based at least in part on the first output, at least one parameter of the first plurality of parameters having the first binary format.

20. The computing system of claim 19, wherein the operations further comprise:
obtaining data indicative of a plurality of parameter update values associated with a second plurality of training iterations, wherein the second plurality of training iterations is performed before the first plurality of training iterations; and
selecting, based at least in part on the plurality of parameter update values, the first binary format.
